(19) United States
(12) Patent Application Publication
(10) Pub. No.: US 2025/0056348 A1
(43) Pub. Date: Feb. 13, 2025

(54) PERFORMING RANDOM ACCESS PROCEDURE FOR LAYER 1 /LAYER 2-TRIGGERED MOBILITY IN WIRELESS NETWORKS

(71) Applicant: SHARP KABUSHIKI KAISHA, Sakai City (JP)

(72) Inventors: MEI-JU SHIH, Taipei (TW); CHIA- HUNG LIN, Taipei (TW); HE-HSUAN LIU, Taipei (TW); PO-CHUN CHOU, Taipei (TW)

(21) Appl. No.: 18/800,503

(22) Filed: Aug. 12, 2024

Related U.S. Application Data
(60) Provisional application No. 63/532,362, filed on Aug. 12, 2023.

(51) Int. Cl. H04W 36/04; H04W 36/00; H04W 56/00; H04W 72/231

(52) U.S. Cl. CPC H04W 36/04; H04W 36/0072; H04W 56/0015; H04W 72/231

(57) ABSTRACT

A method for performing an RA procedure for LTM is provided. The method receives a PDCCH order for initiating the RA procedure for an LTM candidate cell. The PDCCH order indicates that an index of a preamble is not “0.” The PDCCH order includes a first DCI field indicating that a transmission of the preamble is an initial transmission or a re-transmission and a second DCI field indicating the LTM candidate cell. The method increments a power ramping counter by 1 when the first DCI field indicates the re-transmission and the PDCCH order indicates an SSB for the re-transmission of the preamble. The SSB is the same as an SSB used in a previous transmission of the preamble. The method sets, based on the incremented power ramping counter, a power parameter. The method re-transmits, to the LTM candidate cell, the preamble based on at least the set power parameter.

### CROSS-REFERENCE TO RELATED APPLICATION(S)

The present disclosure claims the benefit of and priority to U.S. Provisional Patent Application Ser. No. 63/532,362, filed on Aug. 12, 2023, entitled “METHOD AND APPARATUS FOR UL SYNCHRONIZATION IN LTM,” the content of which is hereby incorporated herein fully by reference into the present disclosure for all purposes.

### FIELD

The present disclosure is related to wireless communication and, more specifically, to a method, a user equipment (UE), and a base station for performing a random access (RA) procedure for layer 1 (L1)/layer 2 (L2)-triggered mobility (LTM) in wireless communication networks.

### BACKGROUND

Various efforts have been made to improve different aspects of wireless communication for the cellular wireless communication systems, such as the 5th Generation (5G) New Radio (NR), by improving data rate, latency, reliability, and mobility. The 5G NR system is designed to provide flexibility and configurability to optimize network services and types, accommodating various use cases, such as enhanced Mobile Broadband (eMBB), massive Machine-Type Communication (mMTC), and Ultra-Reliable and Low-Latency Communication (URLLC). As the demand for radio access continues to grow, however, there is a need for further improvements in wireless communications in the next-generation wireless communication systems.

### SUMMARY

The present disclosure is related to a method, a user equipment (UE), and a base station for performing a random access (RA) procedure for layer 1 (L1)/layer 2 (L2)-triggered mobility (LTM) in cellular wireless communication networks.

In a first aspect of the present application, a method for performing, by a UE, a random access (RA) procedure for layer 1 (L1)/layer 2 (L2)-triggered mobility (LTM) is provided. The method includes receiving, from a source cell, multiple candidate cell configurations; receiving, from the source cell, a physical downlink control channel (PDCCH) order for initiating the RA procedure for an LTM candidate cell, the PDCCH order indicating that an index of a preamble for the RA procedure is not “0” and including a first downlink control information (DCI) field indicating that a transmission of the preamble is an initial transmission or a re-transmission and a second DCI field indicating the LTM candidate cell; incrementing a power ramping counter by 1 in a case that the first DCI field indicates that the transmission of the preamble is the re-transmission and the PDCCH order further indicates a synchronization signal block (SSB) for the re-transmission of the preamble for the LTM candidate cell, the SSB being the same as an SSB that was used in a previous transmission of the preamble for the LTM candidate cell; setting, based on the incremented power ramping counter, a power parameter for the re-transmission of the preamble; and re-transmitting, to the LTM candidate cell, the preamble based on the set power parameter and a physical random access channel (PRACH) resource configured by a candidate cell configuration of the multiple candidate cell configurations. The candidate cell configuration is associated with the LTM candidate cell.

In an implementation of the first aspect, the second DCI field indicates the LTM candidate cell by indicating an index of the candidate cell configuration associated with the LTM candidate cell.

In another implementation of the first aspect, the first DCI field includes a bit to indicate that the transmission of the preamble is the initial transmission or the re-transmission, in a case that the bit is “0”, the bit indicates that the transmission of the preamble is the initial transmission, and in a case that the bit is “1”, the bit indicates that the transmission of the preamble is the re-transmission.

In a second aspect of the present application, a UE for performing a random access (RA) procedure for layer 1 (L1)/layer 2 (L2)-triggered mobility (LTM) is provided. The UE includes at least one processor and at least one non-transitory computer-readable medium coupled to the at least one processor. The at least one non-transitory computer-readable medium stores one or more computer-executable instructions that, when executed by the at least one processor, cause the UE to receive, from a source cell, multiple candidate cell configurations; receive, from the source cell, a physical downlink control channel (PDCCH) order for initiating the RA procedure for an LTM candidate cell, the PDCCH order indicating that an index of a preamble for the RA procedure is not “0” and including a first downlink control information (DCI) field indicating that a transmission of the preamble is an initial transmission or a re-transmission and a second DCI field indicating the LTM candidate cell; increment a power ramping counter by 1 in a case that the first DCI field indicates that the transmission of the preamble is the re-transmission and the PDCCH order further indicates a synchronization signal block (SSB) for the re-transmission of the preamble for the LTM candidate cell, the SSB being the same as an SSB that was used in a previous transmission of the preamble for the LTM candidate cell; set, based on the incremented power ramping counter, a power parameter for the re-transmission of the preamble; and re-transmit, to the LTM candidate cell, the preamble based on the set power parameter and a physical random access channel (PRACH) resource configured by a candidate cell configuration of the multiple candidate cell configurations. The candidate cell configuration is associated with the LTM candidate cell.

In a third aspect of the present application, a method for performing, by a based station, a random access (RA) procedure for layer 1 (L1)/layer 2 (L2)-triggered mobility (LTM) is provided. The method includes transmitting, to a user equipment (UE), multiple candidate cell configurations; transmitting, to the UE, a physical downlink control channel (PDCCH) order for initiating the RA procedure for an LTM candidate cell, the PDCCH order indicating that an index of a preamble for the RA procedure is not “0” and including a first downlink control information (DCI) field indicating that a transmission of the preamble is an initial transmission or a re-transmission and a second DCI field indicating the LTM candidate cell; and receive, from the UE, the preamble based on a physical random access channel (PRACH) resource configured by a candidate cell configuration of the multiple candidate cell configurations. The candidate cell configuration is associated with the LTM candidate cell.

In an implementation of the third aspect, the second DCI field indicates the LTM candidate cell by indicating an index of the candidate cell configuration associated with the LTM candidate cell.

In another implementation of the third aspect, the first DCI field includes a bit to indicate that the transmission of the preamble is the initial transmission or the re-transmission, in a case that the bit is “0”, the bit indicates that the transmission of the preamble is the initial transmission, and in a case that the bit is “1”, the bit indicates that the transmission of the preamble is the re-transmission.

In another implementation of the third aspect, the first DCI field indicates that the transmission of the preamble is the re-transmission, and the PDCCH order further indicates a synchronization signal block (SSB) for the re-transmission of the preamble for the LTM candidate cell, the SSB being the same as an SSB that was used in a previous transmission of the preamble for the LTM candidate cell.

### BRIEF DESCRIPTION OF THE DRAWINGS

Aspects of the present disclosure are best understood from the following detailed disclosure when read with the accompanying drawings. Various features are not drawn to scale. Dimensions of various features may be arbitrarily increased or reduced for clarity of discussion.

FIG. 1 is a flowchart illustrating a method/process for performing, by a UE, an RA procedure for LTM, according to an example implementation of the present disclosure.

FIG. 2 is a flowchart illustrating a method/process for performing, by a BS, an RA procedure for LTM, according to an example implementation of the present disclosure.

FIG. 3 is a block diagram illustrating a node for wireless communication, according to an example implementation of the present disclosure.

### DETAILED DESCRIPTION

Some of the abbreviations used in the present disclosure include:

| Abbreviation | Full name |
|---|---|
| 3GPP | 3^{rd} Generation Partnership Project |
| 5G | 5^{th} Generation |
| ACK | Acknowledgment |
| BS | Base Station |
| BWP | Bandwidth Part |
| CA | Carrier Aggregation |
| CC | Component Carrier |
| CG | Configured Grant |
| CHO | Conditional Handover |
| CJT | Coherent Joint Transmission |
| CRC | Cyclic Redundancy Check |
| CSI-RS | Channel State Information Reference Signal |
| DAPS | Dual Active Protocol Stack |
| DC | Dual Connectivity |
| DCI | Downlink Control Information |
| DL | Downlink |
| DM-RS | Demodulation Reference Signal |
| DU | Distributed Unit |
| E-UTRA | Evolved Universal Terrestrial Radio Access |
| FR | Frequency Range |
| HARQ | Hybrid Automatic Repeat Request |
| HARQ-ACK | HARQ Acknowledgement |
| HO | Handover |
| ID | Identifier |
| IE | Information Element |
| L1/L2/L3 | Layer 1/Layer 2/Layer 3 |
| LTE | Long Term Evolution |
| MAC | Medium Access Control |
| MAC CE | MAC Control Element |
| MCG | Master Cell Group |
| MCS | Modulation Coding Scheme |
| MN | Master Node |
| mTRP | Multi-TRP |
| NAS | Non Access Stratum |
| NR | New Radio |
| NW | Network |
| NZP | Non-Zero Power |
| OFDM | Orthogonal Frequency Division Multiplexing |
| PCell | Primary Cell |
| PCI | Physical Cell Identifier |
| PDCCH | Physical Downlink Control Channel |
| PDSCH | Physical Downlink Shared Channel |
| PH | Power Headroom |
| PHY | Physical (layer) |
| PRACH | Physical Random Access Channel |
| PUCCH | Physical Uplink Control Channel |
| PUSCH | Physical Uplink Shared Channel |
| QCL | Quasi-colocation |
| RA | Random Access |
| RACH | Random Access Channel |
| RAN | Radio Access Network |
| Rel | Release |
| RF | Radio Frequency |
| RLF | Radio Link Failure |
| RNTI | Radio Network Temporary Identifier |
| RRC | Radio Resource Control |
| RS | Reference Signal |
| RSRP | Reference Signal Received Power |
| RSSI | Received Signal Strength Indicator |
| Rx | Reception |
| SCell | Secondary Cell |
| SCG | Secondary Cell Group |
| SDM | Spatial Division Multiplexing |
| SFN | Single-Frequency Network |
| SINR | Signal to Interference plus Noise Ratio |
| SN | Secondary Node |
| SSB | Synchronization Signal Block |
| sTRP | Single-TRP |
| TA | Timing Advance |
| TAG | Timing Advance Group |
| TB | Transport Block |
| TCI | Transmission Configuration Indicator |
| TRP | Transmission Reception Point |
| TS | Technical Specification |
| Tx | Transmission |
| UE | User Equipment |
| UL | Uplink |
| URLLC | Ultra-Reliable and Low-Latency Communication |

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art.

Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For consistency and ease of understanding, like features may be identified (although, in some examples, not illustrated) by the same numerals in the drawings. However, the features in different implementations may be different in other respects and shall not be narrowly included to what is illustrated in the drawings.

References to “one implementation,” “an implementation,” “example implementation,” “various implementations,” “some implementations,” “implementations of the present application,” etc., may indicate that the implementation(s) of the present application so described may include a particular feature, structure, or characteristic, but not every possible implementation of the present application necessarily includes the particular feature, structure, or characteristic. Further, repeated use of the phrase “in one implementation,” or “in an example implementation,” “an implementation,” do not necessarily refer to the same implementation, although they may. Moreover, any use of phrases like “implementations” in connection with “the present application” are never meant to characterize that all implementations of the present application must include the particular feature, structure, or characteristic, and should instead be understood to mean “at least some implementations of the present application” includes the stated particular feature, structure, or characteristic. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent.

The expression “at least one of A, B and C” or “at least one of the following: A, B and C” means “only A, or only B, or only C, or any combination of A, B and C.” The terms “system” and “network” may be used interchangeably. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

For the purposes of explanation and non-limitation, specific details, such as functional entities, techniques, protocols, and standards, are set forth for providing an understanding of the disclosed technology. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software, or a combination of software and hardware. Disclosed functions may correspond to modules which may be software, hardware, firmware, or any combination thereof.

A software implementation may include computer executable instructions stored on a computer-readable medium, such as memory or other type of storage devices. One or more microprocessors or general-purpose computers with communication processing capability may be programmed with corresponding executable instructions and perform the disclosed network function(s) or algorithm(s).

The microprocessors or general-purpose computers may include Application-Specific Integrated Circuits (ASICs), programmable logic arrays, and/or one or more Digital Signal Processor (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture, such as a Long-Term Evolution (LTE) system, an LTE-Advanced (LTE-A) system, an LTE-Advanced Pro system, or a 5G NR Radio Access Network (RAN) typically includes at least one base station (BS), at least one UE, and one or more optional network elements that provide connection within a network. The UE communicates with the network, such as a Core Network (CN), an Evolved Packet Core (EPC) network, an Evolved Universal Terrestrial RAN (E-UTRAN), a 5G Core (5GC), or an internet via a RAN established by one or more BSs.

A UE may include, but is not limited to, a mobile station, a mobile terminal or device, or a user communication radio terminal. The UE may be a portable radio equipment that includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a RAN.

The BS may be configured to provide communication services according to at least a Radio Access Technology (RAT) such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

The BS may include, but is not limited to, a node B (NB) in the UMTS, an evolved node B (eNB) in LTE or LTE-A, a radio network controller (RNC) in UMTS, a BS controller (BSC) in the GSM/GERAN, an ng-eNB in an Evolved Universal Terrestrial Radio Access (E-UTRA) BS in connection with 5GC, a next generation Node B (gNB) in the 5G-RAN, or any other apparatus capable of controlling radio communication and managing radio resources within a cell. The BS may serve one or more UEs via a radio interface.

The BS may be operable to provide radio coverage to a specific geographical area using multiple cells forming the RAN. The BS may support the operations of the cells. Each cell is operable to provide services to at least one UE within its radio coverage.

Each cell (often referred to as a serving cell) may provide services to serve one or more UEs within its radio coverage, such that each cell may schedule the DL and optionally UL resources to at least one UE within its radio coverage for DL and optionally UL packet transmissions. The BS may communicate with one or more UEs in the radio communication system via multiple cells.

A cell may allocate sidelink (SL) resources for supporting Proximity Service (ProSe) or Vehicle to Everything (V2X) service. Each cell may have overlapped coverage areas with other cells.

In Multi-RAT Dual Connectivity (MR-DC) cases, the primary cell of a Master Cell Group (MCG) or a Secondary Cell Group (SCG) may be called a Special Cell (SpCell). A Primary Cell (PCell) may include the SpCell of an MCG. A Primary SCG Cell (PSCell) may include the SpCell of an SCG. MCG may include a group of serving cells associated with the Master Node (MN), including the SpCell and optionally one or more Secondary Cells (SCells). An SCG may include a group of serving cells associated with the Secondary Node (SN), including the SpCell and optionally one or more SCells.

As disclosed above, the frame structure for NR supports flexible configurations for accommodating various next generation (e.g., 5G) communication requirements, such as Enhanced Mobile Broadband (eMBB), Massive Machine Type Communication (mMTC), and Ultra-Reliable and Low-Latency Communication (URLLC), while fulfilling high reliability, high data rate, and low latency requirements. The Orthogonal Frequency-Division Multiplexing (OFDM) technology in the 3GPP may serve as a baseline for an NR waveform. The scalable OFDM numerology, such as adaptive sub-carrier spacing, channel bandwidth, and Cyclic Prefix (CP), may also be used.

Two coding schemes may be considered for NR, specifically Low-Density Parity-Check (LDPC) code and Polar Code. The coding scheme adaptation may be configured based on channel conditions and/or service applications.

At least DL transmission data, a guard period, and UL transmission data should be included in a transmission time interval (TTI) of a single NR frame. The respective portions of the DL transmission data, the guard period, and the UL transmission data should also be configurable based on, for example, the network dynamics of NR. SL resources may also be provided in an NR frame to support ProSe services or V2X services.

Multiple PLMNs may operate on the unlicensed spectrum. Multiple PLMNs may share the same unlicensed carrier. The PLMNs may be public or private. Public PLMNs may be (but are not limited to) the operators or virtual operators, which provide radio services to the public subscribers. Public PLMNs may own the licensed spectrum and support the radio access technology on the licensed spectrum as well. Private PLMNs may be (but are not limited to) the micro-operators, factories, or enterprises, which provide radio services to its private users (e.g., employees or machines). In some implementations, public PLMNs may support multiple deployment scenarios (e.g., carrier aggregation between licensed band NR (PCell) and NR-U (SCell), dual connectivity between licensed band LTE (PCell) and NR-U (PSCell), stand-alone NR-U, an NR cell with DL in unlicensed band and UL in licensed band, dual connectivity between licensed band NR (PCell) and NR-U (PSCell)). In some implementations, private PLMNs mainly support (but are not limited to) the stand-alone unlicensed radio access technology (e.g., stand-alone NR-U).

Any two or more than two of the following paragraphs, (sub)-bullets, points, actions, behaviors, terms, or claims described in the present disclosure may be combined logically, reasonably, and properly to form a specific method.

Any sentence, paragraph, (sub)-bullet, point, action, behavior, term, or claim described in the present disclosure may be implemented independently and separately to form a specific method.

Dependency, e.g., “based on”, “more specifically”, “preferably”, “in one embodiment”, “in some implementations”, etc., in the present disclosure is just one possible example and shall not restrict the specific method.

“A and/or B” in the present disclosure may include either A or B, both A and B, at least one of A and B.

Descriptions of some selected terms in the present disclosure are provided as follows.

The terms “network (NW),” “cell,” “camped cell,” “serving cell,” “base station,” “gNB,” “eNB,” and “ng-eNB” may be used interchangeably. In some implementations, some of these terms may be referred to as the same network entity.

The RAT may be (but is not limited to be) NR, LTE, E-UTRA connected to 5GC, LTE connected to 5GC, E-UTRA connected to EPC, and LTE connected to EPC. The proposed mechanism in the present disclosure may be applied for UEs in public networks, or in private network (e.g., non-public network (NPN), standalone NPN (SNPN), public network integrated NPN (PNI-NPN)).

The proposed mechanism in the present disclosure may be used for licensed frequency and/or unlicensed frequency.

System information (SI): The SI may include the MIB, SIB1, and other SI. The minimum SI may include the MIB and/or SIB1. The other SI may include the SIB3, SIB4, SIB5, and other SIB(s).

The dedicated signaling may include (but is not limited to) the RRC message(s). For example, the RRC message(s) may include one or more of the RRC (Connection) Setup Request message, RRC (Connection) Setup message, RRC (Connection) Setup Complete message, RRC (Connection) Reconfiguration message, RRC Connection Reconfiguration message including the mobility control information, RRC Connection Reconfiguration message without the mobility control information inside, RRC Reconfiguration message including the configuration with sync, RRC Reconfiguration message without the configuration with sync inside, RRC (Connection) Reconfiguration Complete message, RRC (Connection) Resume Request message, RRC (Connection) Resume message, RRC (Connection) Resume Complete message, RRC (Connection) Reestablishment Request message, RRC (Connection) Reestablishment message, RRC (Connection) Reestablishment Complete message, RRC (Connection) Reject message, RRC (Connection) Release message, RRC System Information Request message, UE Assistance Information message, UE Capability Enquiry message, and UE Capability Information message.

The RRC_CONNECTED UE, RRC_INACTIVE UE, and RRC_IDLE UE may be used to apply the proposed implementations in the present disclosure.

The UE may be served by a cell (e.g., a serving cell). The serving cell may serve (but is not limited to serve) an RRC_CONNECTED UE. The serving cell may be (but is not limited to) a suitable cell.

Primary Cell (PCell): The PCell may be an MCG cell that operates on the primary frequency. The UE may either perform the initial connection establishment procedure or initiate the connection re-establishment procedure in the MCG cell.

Primary SCG Cell (PSCell): For a DC operation, the PScell may be an SCG cell in which the UE may perform the random access when executing the Reconfiguration with a Sync procedure.

Serving Cell: For a UE in an RRC_CONNECTED state not configured with the carrier aggregation (CA)/dual connectivity (DC), there may be only one serving cell including the primary cell. For a UE in an RRC_CONNECTED state configured with the CA/DC, the term “serving cells” may be used to denote a set of cells including the Special Cell(s) and all the secondary cells.

Secondary Cell: For a UE configured with the CA, the secondary cell may include a cell that provides additional radio resources (e.g., in addition to the Special Cell).

Special Cell (SpCell): For a dual connectivity operation, the term “Special Cell” may include the PCell of the MCG or the PSCell of the SCG, otherwise, the term “Special Cell” may include the PCell.

Master Cell Group: In MR-DC, the master cell group may include a group of serving cells associated with the Master Node, including the SpCell (PCell) and optionally one or more SCells.

Master node: In MR-DC, the master node may include the radio access node that provides the control plane connection to the core network. The master node may include a Master eNB (in EN-DC), a Master ng-eNB (in NGEN-DC), or a Master gNB (in NR-DC and NE-DC).

Secondary Cell Group: In MR-DC, the secondary cell group may include a group of serving cells associated with the Secondary Node, including the SpCell (PSCell) and optionally one or more SCells.

Secondary node: In MR-DC, the secondary node may include the radio access node with no control plane connection to the core network, providing additional resources to the UE. The secondary node may be an en-gNB (in EN-DC), a Secondary ng-eNB (in NE-DC), or a Secondary gNB (in NR-DC and NGEN-DC).

The terms “serving cell,” “TRP associated with the PCI of the serving cell,” “TRP associated with the serving cell,” “TRP of a serving cell,” and “TRP of the serving cell” may be used interchangeably in this disclosure.

The terms “target cell,” “target serving cell,” “TRP associated with a PCI different from the PCI of the serving cell,” and “TRP associated with the target cell” may be used interchangeably in this disclosure. A target serving cell may be identified by a PCI or a PCI index. A UE may be configured with at most 1, 4, 8, or 32 PCI indices. Each PCI index may identify a target serving cell of the UE.

The terms “candidate cell,” “neighboring cell,” and “candidate target cell” may be used interchangeably in this disclosure. The serving cell in the described implementations may be a PCell, an SCell or a PSCell. The target cell in the described implementations may be a PCell, an SCell or a PSCell.

An inter-cell associated with the serving cell of the UE may be a neighboring cell, a cell other than the serving cell, or a cell with a PCI different from the PCI of the serving cell. If the UE performs the inter-cell beam management, the UE may be in a coverage of the inter-cell.

The terms “MAC layer” and “MAC entity” may be used interchangeably in this disclosure.

A UE being configured with a unified TCI framework (e.g., a unified TCI configuration) may be equivalent to a UE being configured with a unified TCI state operation.

SpCellConfig: The SpCellConfig may include a serving cell's specific MAC and PHY parameters for an SpCell. The parameters for the SpCell of a cell group (e.g., a PCell of an MCG or a PSCell of an SCG). The SpCellConfig may be included in the CellGroupConfig. The SpCellConfig may include the ServingCellConfig.

SCellConfig: The SCellConfig may be included in the CellGroupConfig. The SCellConfig may include the ServingCellConfig.

ServingCellConfig: The ServingCellConfig IE may be used to configure the UE with a serving cell, which may be an SpCell or an SCell of an MCG or an SCG. The parameters in the ServingCellConfig IE may be mostly UE specific and partly cell specific (e.g., in the additionally configured bandwidth parts). The reconfiguration between a PUCCH and PUCCHless SCell may be only supported by using an SCell release and add.

CellGroupConfig: The CellGroupConfig may include the configuration of one Cell-Group. The CellGroupConfig IE may be used to configure a master cell group (MCG) or a secondary cell group (SCG). A cell group may include a MAC entity, a set of logical channels with associated RLC entities of a primary cell (SpCell), and one or more secondary cells (SCells).

A UE determining that an L1/L2 mobility enhancement is failed may include the UE determining that the RRC pre-configuration step is failed, the UE determining that the cell switch is failed, the UE determining that the L1 measurement and reports are failed, the UE determining that the DL synchronization is failed, the UE determining that the UL synchronization is failed, and/or the UE determining that the subsequent cell switches are failed.

A UE determining that an L1/L2 mobility enhancement is completed successfully may include the UE determining that the RRC pre-configuration step is completed successfully, the UE determining that the cell switch is completed successfully, the UE determining that the L1 measurement and reports are completed successfully, the UE determining that the DL synchronization is completed successfully, the UE determining that the UL synchronization is completed successfully, and the UE determining that the subsequent cell switches are completed successfully.

In some implementations, the source gNB/cell may include the gNB/cell that serves the UE when the UE receives the RRC message during the RRC pre-configuration step. For example, the source gNB/cell in the cell switch and the subsequent cell switch may include the same source gNB/cell. In some implementations, the source gNB/cell may include the gNB/cell that serves the UE before the UE switches to a new cell. For example, the source gNB/cell in the cell switch step and the source gNB/cell in the subsequent cell switch step may include different source gNBs/cells.

In some implementations, the previous selected target gNB/cell may include the selected target gNB/cell in the previous cell switch per RRC pre-configuration. For example, the UE may perform a first cell switch and a subsequent cell switch based on one RRC pre-configuration. The RRC pre-configuration may be provided to the UE by the source gNB/cell. The UE may select a target gNB/cell in the first cell switch. During the first cell switch, the UE may switch to the selected target gNB/cell from the source gNB/cell. During the subsequent cell switch, the selected target gNB/cell may become the UE's previous selected target gNB/cell. During the subsequent cell switch, the UE may select another target gNB/cell and perform the subsequent cell switch from the previous selected target gNB/cell to the other selected target gNB/cell.

LTM: A PCell (or PSCell) cell switch procedure that the network triggers via the MAC CE based on the L1 measurement.

RACH-less LTM: An LTM cell switch procedure in which the UE skips the RA procedure.

Subsequent LTM: Subsequent LTM cell switch procedures between the candidate cells in which the UE does not need to be reconfigured by the network in between the cell switchings.

The cell switch command may include, but is not limited to, the LTM cell switch command MAC CE.

The reference signal may include, but is not limited to, the SSB, CSI-RS, TRS, PT-RS, SRS, and DM-RS.

In some implementations, the source gNB/cell/PCell may include the gNB/cell/PCell in which the UE receives the RRC pre-configuration (e.g., RRC Reconfiguration message) and/or the cell switch command. When the subsequent cell switch is considered, the source gNB/cell/PCell may include the gNB/cell/PCell in which the UE receives the RRC pre-configuration (e.g., RRC Reconfiguration message) and/or the cell switch command for the subsequent cell switch. It may be possible that during a subsequent cell switch, the target gNB/cell/PCell in the first cell switch may become the source gNB/cell/PCell in the second cell switch. Furthermore, it may be possible that during a subsequent cell switch, the target gNB/cell/PCell in the N-th cell switch may become the source gNB/cell/PCell in the (N+1)-th cell switch, where N is a positive integer.

In a wireless cellular network, the mobile devices (e.g., UE) may move from the coverage area of one cell to another cell. To avoid the connection interruption and to ensure the service continuity, a handover procedure may be applied for the mobile device when the handover procedure is triggered under certain conditions (e.g., when the signal quality of the source cell becomes poorer than a threshold for a period of time).

Conventionally, a handover procedure may be triggered by the Layer 3 (L3) measurements and may be completed by the RRC signaling triggered Reconfiguration with Synchronization for the change of PCell and PSCell and for the release and addition of SCells. In addition, the conditional handover (CHO) has been proposed to enhance the robustness so that the mobile device may receive the configuration of the target cell in advance (e.g., when the signal quality between the mobile device and the source cell is stable). The dual active protocol stack (DAPS) handover has been proposed to reduce the interruption time since the mobile device may maintain two protocol stacks (e.g., one is associated with the source cell and another one is associated with the target cell) for simultaneous connections with the source cell and the target cell during the handover.

The handover procedures, conditional handovers, and DAPS handovers may require a complete Layer 2 (L2) reset and Layer 1 (L1) reset. The L2 may include a Medium Access Control (MAC) layer, a Radio Link Control (RLC) layer, and a Packet Data Convergence Protocol (PDCP) layer. The L1 may include a Physical (PHY) layer. The complete L1/L2 reset may result in a longer latency, larger overhead, and longer interruption time than the beam switching mobility. Thus, it is desirable to evaluate the L1/L2 mobility enhancement (e.g., enabling a serving cell to change via the L1/L2 signaling) to reduce the latency, overhead, and interruption time during the handover procedure.

The L1/L2 mobility enhancement may be targeted at reducing the latency, overhead, and interruption time due to the UE mobility (e.g., by enabling a serving cell to change via the L1/L2 signaling) for the handover procedure. The L1/L2 mobility enhancement may involve the RRC pre-configuration of the information associated with the candidate target cells, L1 measurement and report, DL synchronization with the candidate target cells, UL synchronization with the candidate target cells, cell switch to the target cell, and subsequent cell switch to the target cells, etc. The early timing advance (TA) acquisition of the LTM candidate cell may be an important mechanism in the L1/L2 mobility enhancement in order to reduce the latency and interruption time. In the present disclosure, the implementations focus on the initialization of the PDCCH ordered early RACH to the LTM candidate cell and Random Access Preamble transmission to the LTM candidate cell. Moreover, the subsequent cell switch may be also addressed to reduce the time of the RRC (re) configuration. The implementations provided in the present disclosure are expected to be more efficient (e.g., signaling overhead reduction and energy-efficient) and reliable.

### L1/L2-Triggered Mobility

The L1/L2 mobility enhancement may include, but is not limited to, the L1/L2-triggered Mobility (LTM). Generally, lots of mobility enhancements from different perspectives and from different protocol layers may be proposed to realize the LTM. The LTM may be a procedure that involves, but is not limited to, an RRC pre-configuration step, an L1 measurement and report step, a DL synchronization step, a UL synchronization step, and a (subsequent) cell switch step.

In the present disclosure, the terms “LTM,” “L1/L2-triggered mobility,” and “L1/L2 mobility enhancements” may be used interchangeably. The terms “RRC pre-configuration,” “RRC pre-configuration step,” “RRC pre-configuration,” “RRC pre-configuration step,” “RRC (pre) configuration,” and “RRC (pre) configuration step” may be used interchangeably. The terms “L1 measurement and reports” and “L1 measurement and reports step” may be used interchangeably. The terms “DL synchronization” and “DL synchronization step” may be used interchangeably. The terms “UL synchronization” and “UL synchronization step” may be used interchangeably. The terms “Cell switch” and “cell switch step” may be used interchangeably. The terms “Subsequent cell switch” and “subsequent cell switch step” may be used interchangeably.

### RRC Pre-Configuration

During the RRC pre-configuration step, the source gNB/cell may transmit the information/configuration associated with the candidate target cells to the UE via the RRC signaling. The source gNB/cell may prepare one or multiple candidate target cells (e.g., for LTM procedure and/or handover), generate the RRC message (e.g., the RRC Reconfiguration message) and/or information element (IE) (e.g., the CellGroupConfig IE, LTM-specific IE) including the information/configuration associated with the candidate target cells, and/or may transmit the generated RRC message and/or IE to the UE. Upon receiving the information/configuration associated with the candidate target cells, the UE may store and/or apply the received information/configuration for the handover procedures (e.g., the L1/L2-triggered mobility). The RRC message (e.g., the RRC Reconfiguration message) may include the information (IE) (e.g., the CellGroupConfig IE, LTM-specific IE).

In some implementations, upon receiving the information/configuration associated with the candidate target cells, the UE may release (e.g., part of) the stored information/configuration associated with the candidate target cells, if any, and the UE may then store and/or apply the newly received information/configuration associated with the candidate target cells. The stored information/configuration associated with the candidate target cells may be included in the previous RRC message and/or IE received by the UE from the source gNB/cell, and the RRC message and/or IE may include the information/configuration associated with the candidate target cells. In some implementations, the RRC message (or a previous RRC message) may include the IE(s), and the IE(s) may include the information/configuration associated with the candidate target cells.

In some implementations, upon receiving the information/configuration associated with the candidate target cells, the UE may release the stored information/configuration associated with a first set of candidate target cells, if any, and the UE may then store and/or apply the newly received information/configuration associated with a second set of the candidate target cells. In some implementations, some candidate target cells in the first set may be the same as some candidate target cells in the second set, while some candidate target cells in the first set may be different from some candidate target cells in the second set. In some implementations, all candidate target cells in the first set are different from those candidate target cells in the second set.

In some implementations, the source gNB/cell may determine the candidate target cells (e.g., in the first set and in the second set) based on at least one of the network topology, network deployment, (L1/L3) measurement report from the UE, network configuration, etc. In some implementations, upon receiving the information/configuration associated with the candidate target cells, the UE may replace the stored information/configuration associated with a first set of candidate target cells, if any, with the newly received information/configuration associated with a second set of the candidate target cells.

In some implementations, upon receiving the information/configuration associated with the candidate target cells, the UE may release the stored information/configuration associated with a first set of candidate target cells, if any, and not release the stored information/configuration associated with a second set of candidate target cells. The UE may then store and/or apply the newly received information/configuration associated with a third set of the candidate target cells. In some implementations, the source gNB/cell may determine the sets of candidate target cells (e.g., in the first set, the second set, or the third set) based on at least one of the network topology, network deployment, (L1/L3) measurement report from the UE, network configuration, etc.

In some implementations, the source gNB/cell may transmit the RRC Reconfiguration message including the determined sets of candidate target cells (e.g., a list of candidate target cell IDs (or indices) for the first set, a list of candidate target cell IDs (or indices) for the second set, or a list of candidate target cell IDs (or indices) for the third set) to the UE. In some implementations, the source gNB/cell may transmit the RRC Reconfiguration message including the determined set of candidate target cells. For example, each configuration corresponding to a set of different candidate target cells may include a set ID used to indicate that the candidate target cell is associated with which determined set of candidate target cells. If the set ID indicates ‘first set,’ the candidate target cell associated with that set ID may belong to the first set of candidate target cells. If the set ID indicates ‘second set,’ the candidate target cell associated with that set ID may belong to the second set of candidate target cells. If the set ID indicates ‘third set,’ the candidate target cell associated with that set ID may belong to the third set of candidate target cells.

### L1 Measurement and Reports

The UE may perform the L1 measurement and reports in the LTM procedure. Based on the measurement configuration, the UE may perform the L1 measurement on the neighboring cells and/or on the candidate target cells. The UE may receive the measurement configuration from the source gNB/cell via RRC signaling (e.g., during, before, and/or after the RRC pre-configuration step). That is, the UE may perform the L1 measurement and reports before or after the RRC pre-configuration step in the LTM procedure. The measurement configuration may include information/configuration that the UE requires to perform the L1 measurement.

The information/configuration that the UE requires to perform the L1 measurement may include, but is not limited to, the reference resource configuration associated with the neighboring cells and/or the candidate target cells to be measured. For example, the UE may measure the received signal quality and/or the received signal strength on at least one of the reference resources (or reference signals (RSs)) (e.g., the synchronization signal blocks (SSBs), channel state information-RSs (CSI-RSs), tracking RSs (TRSs)) associated with the neighboring cells and/or the candidate target cells. In some implementations, the reference resource configuration may include the association among the at least one of the reference resources and the neighboring cells and/or the candidate target cells. In some implementations, the measurement configuration may include the association among the at least one of reference resources and the neighboring cells and/or the candidate target cells.

The UE may report the L1 measurement results to the source gNB/cell, periodically, by an event, after the L1 measurements, or after an event is triggered. The UE may receive the report configuration from the source gNB/cell via the RRC signaling (e.g., before, during, and/or after the RRC pre-configuration step). The UE may report the L1 measurement results to the source gNB/cell via the RRC message and/or the lower layer signaling (e.g., the uplink control information (UCI)). The UE may report the L1 measurement results to the source gNB/cell via the PUCCH, PUSCH, and/or MAC CE. The L1 measurement results may include, but are not limited to, the RS index of the reference resources associated with the neighboring cells and/or candidate target cells to be measured, the reference signal received power (RSRP) values of the reference resources associated with the neighboring cells and/or candidate target cells to be measured, and/or the reference signal received quality (RSRQ) values of the reference resources associated with the neighboring cells and/or candidate target cells to be measured.

The UE may report the RSRP values of the reference resources associated with the neighboring cells and/or candidate target cells to be measured, and/or the RSRQ values of the reference resources associated with the neighboring cells and/or candidate target cells to be measured. The measurement results may be reported to the source gNB/cell, one or more candidate target cell(s) configured to the UE for channel quality/strength measurement and report, and/or at least one of the candidate target cells indicated in the RRC pre-configuration step. The report configuration may include at least one of the information of when the UE reports the L1 measurement results, a timer value (e.g., how long the UE reports the measurement results, the periodicity to report the measurement results), the information of resources on which the UE reports the L1 measurement results, the information of reference resources based on which the UE reports the L1 measurement results, etc.

The report configuration may include one or more thresholds for a UE to determine whether to transmit the L1 measurement report(s) corresponding to the measurement results of the reference resources associated with the neighboring cells and/or candidate target cells to be measured. The one or more thresholds may include an RSRP threshold value or an RSRQ threshold value.

In some implementations, the report configuration may include an RSRP threshold value. A UE may measure the RSRP value(s) of the reference resources associated with the neighboring cells and/or candidate target cells. After the L1 measurement, the UE may report which neighboring cells and/or candidate target cells have the better channel conditions (e.g., their measured RSRP value is higher than or equal to the RSRP threshold value), to the source gNB/cells and/or one or more candidate target cells. For example, the UE may report the cell identities, cell indices, PCI(s), and/or additional PCI indices associated with the neighboring cells and/or candidate target cells, the measured RSRP value of which is higher than or equal to the RSRP threshold value, to the source gNB/cells and/or one or more candidate target cells.

In some implementations, the report configuration may include an RSRQ threshold value. A UE may measure the RSRQ value(s) of the reference resources associated with the neighboring cells and/or candidate target cells. After the L1 measurement, the UE may report which neighboring cells and/or candidate target cells have the better channel conditions (e.g., their measured RSRQ is higher than or equal to the RSRQ threshold), to the source gNB/cells and/or one or more candidate target cells. For example, the UE may report the cell identities, cell indices, PCI(s), and/or additional PCI indices associated with the neighboring cells and/or candidate target cells, the measured RSRQ value is higher than or equal to the RSRQ threshold value, to the source gNB/cells and/or one or more candidate target cells.

In some implementations, a UE may report one neighboring cell and/or candidate target cell that has a better channel condition (e.g., its measured RSRP value is higher than or equal to the RSRP threshold value, or its measured RSRQ is higher than or equal to the RSRQ threshold value) to the source gNB/cells and/or one or more candidate target cells. In a case that there are more than one neighboring cell and/or candidate target cell that have the better channel conditions (e.g., their measured RSRP value is higher than or equal to the RSRP threshold value, or their measured RSRQ value is higher than or equal to the RSRQ threshold value), the UE may report a neighboring cell and/or candidate target cell, that has the largest RSRP/RSRQ value, to the source gNB/cells and/or to one or more candidate target cells, or the UE may report any one of the neighboring cells and/or candidate target cells, that have the better channel conditions, to the source gNB/cells and/or to one or more candidate target cells.

In some implementations, a UE may report more than one neighboring cell and/or candidate target cell that have the better channel conditions (e.g., their measured RSRP value is higher than or equal to the RSRP threshold value or their measured RSRQ value is higher than or equal to the RSRQ threshold value) to the source gNB/cells and/or one or more candidate target cells. In a case that more than one neighboring cell and/or candidate target cell have better channel conditions (e.g., their measured RSRP value is higher than or equal to the RSRP threshold value or their measured RSRQ value is higher than or equal to the RSRQ threshold value), the UE may report all the neighboring cells and/or candidate target cells that have the better channel conditions to the source gNB/cells and/or one or more candidate target cells or the UE may report some of the neighboring cells and/or candidate target cells that have the better channel conditions (e.g., with the largest Nth RSRP/RSRQ values) to the source gNB/cells and/or one or more candidate target cells.

In some implementations, a UE may report more than one neighboring cell and/or candidate target cell that have the better channel conditions (e.g., their measured RSRP value is higher than or equal to the RSRP threshold value or their measured RSRQ value is higher than or equal to the RSRQ threshold value) to the source gNB/cells and/or to one or more candidate target cells. In a case that (only) one neighboring cell and/or candidate target cell has the better channel condition (e.g., its measured RSRP value is higher than or equal to the RSRP threshold value or its measured RSRQ value is higher than or equal to the RSRQ threshold value), the UE may report the (only) one neighboring cell and/or candidate target cell to the source gNB/cells and/or to one or more candidate target cells, or the UE may switch to an L3 HO (e.g., through a CHO, DAPS).

In some implementations, a UE may report more than one neighboring cell and/or candidate target cell that have the better channel conditions (e.g., their measured RSRP value is higher than or equal to the RSRP threshold value or their measured RSRQ value is higher than or equal to the RSRQ threshold value) to the source gNB/cells and/or to one or more candidate target cells. The maximum number of the neighboring cells and/or candidate target cells that have the better channel conditions that may be reported by the UE may be configured by the source gNB/cell to the UE via the RRC signaling. The UE may report its UE capability in a UE Capability Information message to the source gNB/cell. The UE capability may include the information of the maximum number of the neighboring cells and/or candidate cells that it may measure and/or report to the source gNB/cell. The UE may report such UE capability to the source gNB/cell in response to the reception of a UE Capability Enquiry message received from the source gNB/cell.

For example, the UE may report the information (e.g., identities/indices) associated with the neighboring cells with the top-N1 RSRP values that are higher than or equal to the RSRP threshold value, the information (e.g., identities/indices) associated with the candidate target cells with the top-N2 RSRP values that are higher than or equal to the RSRP threshold value, and/or the information (e.g., identities/indices) associated with the neighboring cells and/or candidate target cells with the top-(N1+N2) RSRP values that are higher than or equal to the RSRP threshold value, to the source gNB/cell. For example, the UE may report the information (e.g., identities/indices) associated with the neighboring cells with the top-N1 RSRQ values higher than or equal to the RSRQ threshold value, the information (e.g., identities/indices) associated with the candidate target cells with the top-N2 RSRQ values higher than or equal to the RSRQ threshold value, and/or the information (e.g., identities/indices) associated with the neighboring cells and/or candidate target cells with the top-(N1+N2) RSRQ values higher than or equal to the RSRQ threshold value, to the source gNB/cell.

In some implementations, in a case that there are no neighboring cells and/or candidate target cells that have the better channel conditions (e.g., their measured RSRP value is less than the RSRP threshold value or their measured RSRQ value is less than the RSRQ threshold value), a UE may switch to the L3 HO (e.g., through a CHO, DAPS) or the UE may transmit a request (e.g., through an RRC message, a MAC CE, UCI, indication from the upper layer of the UE (e.g., the RRC layer of the UE) to the lower layer of the UE (e.g., the MAC layer of the UE)) to the source gNB/cells for preparing/generating other candidate target cells, generating the RRC message (e.g., the RRC Reconfiguration message), preparing/generating information element (IE) (e.g., the CellGroupConfig IE, LTM-specific IE) including the information/configuration associated with the other candidate target cells, and/or transmitting the prepared/generated RRC message and/or IE, to the UE.

In some implementations, the L1 measurement results may include, but are not limited to, the RSRP values of the reference resources that are covered by the active BWPs of the SpCell and SCells, and/or the RSRP values of the reference resources that are not covered by any of the active BWPs of the SpCell and SCells. In some implementations, the L1 measurement results may include, but are not limited to, the RSRQ values of the reference resources that are covered by the active BWPs of the SpCell and SCells, and/or the RSRQ values of the reference resources that are not covered by any of the active BWPs of the SpCell and SCells.

In some implementations, the L1 measurement results may include, but are not limited to, the signal to interference plus noise ratio (SINR) values that are provided for the active BWPs of the SpCell and SCells, and/or the SINR values that are not provided for any of the active BWPs of the SpCell and SCells. In some implementations, the L1 measurement results may include, but are not limited to, the received signal strength indication (RSSI) values that are provided for the active BWPs of the SpCell and SCells, and/or the RSSI values that are not provided for any of the active BWPs of the SpCell and SCells.

In some implementations, the L1 measurement results may include, but are not limited to, the RSRP values of the reference resources that are covered by the configured BWPs of the SpCell and SCells, and/or the RSRP values of the reference resources that are not covered by any of the configured BWPs of the SpCell and SCells. In some implementations, the L1 measurement results may include, but are not limited to, the RSRQ values of the reference resources that are covered by the configured BWPs of the SpCell and SCells, and/or the RSRQ values of the reference resources that are not covered by any of the configured BWPs of the SpCell and SCells.

In some implementations, the L1 measurement results may include, but are not limited to, the SINR values that are provided for the configured BWPs of the SpCell and SCells, and/or the SINR values that are not provided for any of the configured BWPs of the SpCell and SCells. In some implementations, the L1 measurement results may include, but are not limited to, the RSSI values that are provided for the configured BWPs of the SpCell and SCells, and/or the RSSI values that are not provided for any of the configured BWPs of the SpCell and SCells.

### DL Synchronization

The UE may perform the DL synchronization with the selected target cell or with the candidate target cells during the LTM procedure. Generally, the UE may perform the DL synchronization after the cell switch to the selected target cell in order to acquire the DL time and/or frequency synchronization, the DL system information, and the DL data from the selected target cell. In some implementations, the UE may perform the DL synchronization after the cell switch to the selected target cell and after the subsequent cell switch(es) to the selected target cells. However, in some implementations, the UE may perform the DL synchronization before the cell switch to the candidate target cells in order to reduce the interruption time, but this may occur at the cost of increased complexity and overhead. In one cell switch, the UE may switch to a target cell. In some implementations, the UE may perform the DL synchronization before receiving the cell switch command and/or receiving the cell switch command corresponding to the subsequent cell switch.

The UE may receive and/or be configured with the information required for the DL synchronization with the selected target cell or with the candidate target cells from the source gNB/cell via the RRC signaling and/or lower layer signaling (e.g., the L1 signaling or L2 signaling). For example, the UE may receive the RRC message including the information required for the DL synchronization during the RRC pre-configuration from the source gNB/cell. For example, the UE may receive the MAC CE (or the cell switch command or the candidate cell TCI states activation/deactivation MAC CE), including the information required for the DL synchronization, from the source gNB/cell. For example, the UE may receive the DCI that includes the information required for the DL synchronization.

The information required for the DL synchronization may include, but is not limited to, the Identities (IDs) or indices of the candidate target cells, the ID or index of the selected target cell, the indices of the reference signals (e.g., the SSB) associated with the candidate target cells, the indices of the resource blocks associated with the selected target cell, the time/frequency information associated with the candidate target cells, the time/frequency information associated with the selected target cell, and the TCI state ID associated with the candidate target cells or the selected target cell, etc.

The cell switch command or candidate cell TCI states activation/deactivation MAC CE may be a MAC CE that includes the required information (e.g., the beam information, PCI, logical ID (e.g., additionalPCIIndex), DL/UL synchronization information corresponding to the selected candidate target cell) for the UE to switch to the selected target cell, and/or activate (or deactivate) the TCI states associated with the selected target cell. The selected target cell may be one of the candidate target cells that the source gNB/cell indicates to the UE to perform the cell switch.

### UL Synchronization

The UE may perform the UL synchronization (e.g., including the (early) Timing Advance (TA) acquisition, RACH-less LTM procedure, PDCCH-ordered RA procedure with Random Access Response (RAR), PDCCH-ordered RA procedure without RAR and UE-based TA measurement) with the selected target cell or with the candidate target cells during the LTM procedure. Generally, the UE may perform the UL synchronization after the DL synchronization is completed. In some implementations, the UE may perform the UL synchronization with the selected target cell after the cell switch. In some implementations, to reduce the interruption time, the UE may perform the UL synchronization with the candidate target cells before the cell switch, at the cost of increased overhead and complexity. In some implementations, the UE may perform the UL synchronization after the cell switch. In some implementations, the UE may perform the DL synchronization before the cell switch, and the UL synchronization after the cell switch.

In a UE-based TA measurement, the UE may derive the TA(s) for the candidate (or target) cells based on the Rx timing difference between the current serving cell (e.g., the source cell) and the candidate cells as well as the TA value for the current serving cell. The UE-based TA measurement may be supported without performing the PDCCH-ordered RACH for the candidate cells.

In a RACH-less LTM procedure, the UE may acquire the TA for the candidate (or target) cells by receiving the cell switch command from the source serving cell. The cell switch command may indicate the TA value of the target cell as being 0, the same TA value as that of the source serving cell, or any TA values. In some implementations, the UE may perform the RACH-less LTM when the UE switches to the target cell and/or when the UE does not need to acquire the TA during the cell switch (e.g., when the target cell is the (source) SCell or when the target cell is the (source) PSCell). The target cell may include the target PCell.

During the UL synchronization step, the UE may perform a random access (RA) procedure (e.g., a contention-based random access procedure, a contention-free random access procedure, a 2-step RA procedure, or a 4-step RA procedure) with the selected target cell or with the candidate target cells in order to acquire the UL timing and/or TA information, and/or the UE may transmit the UL data to the selected target cell or to the candidate target cells. In some implementations, during the UL synchronization, the UE may perform a RACH-less procedure (e.g., without performing an RA procedure) with the selected target cell or with the candidate target cells in order to acquire the UL timing and/or TA information, and/or the UE may transmit the UL data to the selected target cell or to the candidate target cells.

The UE may receive the information required for the UL synchronization via the RRC signaling or lower layer signaling (e.g., the MAC CE or DCI) from the source gNB/cell. Upon receiving the information required for the UL synchronization, the UE may configure the information. For example, during the RRC pre-configuration step, the UE may receive the RRC message including the information required for the UL synchronization from the source gNB/cell. As another example, the UE may receive the MAC CE including the information required for the UL synchronization from the source gNB/cell.

The information required for the UL synchronization may include, but is not limited to, the physical random access channel (PRACH) resource configuration associated with the selected target cell, PRACH resource configurations associated with the candidate target cells, preamble sequence configuration associated with the selected target cell, preamble sequence configurations associated with the candidate target cells, indication for performing a RACH-less procedure, indication for performing an RA procedure, indication for indicating to perform 2-step RACH or 4-step RACH, timing advance group index (TAG ID) associated with the selected target cell, TAG IDs associated with the candidate target cells, UL carrier types (e.g., normal UL (NUL), supplementary UL (SUL)) associated with the selected target cell, UL carrier types associated with the candidate target cells, sounding reference signal (SRS) configuration associated with the selected target cell, SRS configurations associated with the candidate target cells, etc.

### (Subsequent) Cell Switch

During the LTM procedure, the source gNB/cell may change the UE's serving cell(s) (e.g., the UE's PCell, UE's SCells, UE's PSCell) using the MAC CE. The source gNB/cell may determine (or select) a target cell among candidate target cells and the source gNB/cell may then transmit the cell switch command (e.g., a MAC CE), to the UE. The cell switch command may include the required information for the UE to switch to the selected target cell. The selected target cell may include, but is not limited to, the neighboring cells, candidate target cells, UE's SCells, and UE's PSCell. The source gNB/cell may determine (or select) the target cell based on, but is not limited to, the candidate target cell configurations provided to the UE during the RRC pre-configuration, the received L1 measurement reports from the UE, the information (e.g., TA related information) transmitted by the candidate target cell, the network topology, the resource availability, etc.

The cell switch command (e.g., a MAC CE, and/or DCI) may include, but is not limited to, the index (e.g., the PCI value, addition PCI index, serving cell index) of the selected target cell, the (unified) TCI state (e.g., the joint TCI state, DL TCI state, UL TCI state) associated with the selected target cell, the TA information (e.g., the TAG ID, TA value, TA Command) associated with the selected target cell, the index of the candidate target cell configuration associated with the selected target cell, the index of the BWP (e.g., the initial BWP, the DL BWP, the UL BWP, the first active downlink BWP, the first active uplink BWP, the BWP the UE may switch to) associated with the selected target cell, the cell type to be switched (e.g., the PCell, SCell, PSCell), the index of the MAC CE as a cell switch command for an RRC pre-configuration, the total number of cell switches per RRC pre-configuration, a dedicated DCI format for informing cell switch, a DCI field including information for cell switch etc. The index of the MAC CE as a cell switch command for an RRC pre-configuration, and the total number of cell switches per RRC pre-configuration may be useful for the subsequent cell switch in the (subsequent) LTM procedure.

After the UE receives the cell switch command (e.g., a MAC CE) from the source gNB/cell, the UE may perform the cell switch to the target cell indicated in the cell switch command and based on the information in the cell switch command. Depending on the content of the cell switch command, the cell switch may include the PCell change (e.g., switch from the source PCell to a target PCell), SCell change (e.g., switch from the source SCell to a target SCell), and/or PSCell change (e.g., switch from the source PSCell to a target PSCell).

In some implementations, if the UE does not release the stored candidate target cell configurations upon the cell switch, and if the UE receives a subsequent cell switch command (e.g., a MAC CE) and/or candidate cell TCI states activation/deactivation MAC CE, the UE may perform the subsequent cell switch. That is, the subsequent LTM between the candidate target cells may be performed by the UE and the gNB/cell without receiving a new RRC (pre) configuration after the first cell switch and before the one or some subsequent cell switches. The RRC pre-configuration for the first cell switch may be applied by the UE for the subsequent cell switches.

In some implementations, the total number of cell switches per RRC (pre) configuration may be configured or pre-defined. For example, the UE may receive the information of the total number of cell switches per RRC (pre) configuration in the RRC message received during the RRC pre-configuration step or in the cell switch command (e.g., especially for the first cell switch after the RRC pre-configuration step). In some implementations, once the UE receives the information of the total number of cell switches per RRC (pre) configuration, the UE may perform the subsequent cell switch. The information of the total number of cell switches per RRC (pre) configuration may indicate that the UE is allowed to perform the subsequent cell switch.

In some implementations, the first cell switch may not be counted for the total number of cell switches per RRC (pre) configuration. In some implementations, the first cell switch may be counted for the total number of cell switches per RRC (pre) configuration. If the number of cell switches that the UE performs per RRC (pre) configuration exceeds (or equals to) the configured/pre-defined total number of cell switches per RRC (pre) configuration, the UE may receive an RRC message for the RRC (pre) configuration from the source gNB/cell (e.g., the source gNB/cell in which the UE receives the RRC (pre) configuration before any cell switch commands, the gNB/cell to which the UE is connected (or by which the UE is served) after the cell switch) or from the target gNB/cell, release the stored candidate target cell configurations, and/or ignore the received cell switch command. If the number of cell switches that the UE performs per RRC (pre) configuration exceeds the configured/pre-defined total number of cell switches per RRC (pre) configuration, the UE may release the stored candidate target cell configurations without receiving any notification from the network, for example, via RRC signaling, MAC CE, or DCI.

The UE may receive the number of cell switches per RRC (pre) configuration to be configured from the source gNB/cell via the RRC signaling (e.g., in the RRC message during the RRC pre-configuration step), and/or via the lower layer signaling (e.g., in the MAC CE during cell switch command). In some implementations, the UE may replace the current value of the total number of cell switches per RRC (pre) configuration with the value of the total number of cell switches per RRC (pre) configuration received from the source gNB/cell upon receiving the RRC signaling or lower layer signaling. In some implementations, the UE may set the value of the total number of cell switches per RRC (pre) configuration to 0 by default if the information of the total number of cell switches per RRC (pre) configuration is absent. In some implementations, the number of cell switches per RRC (pre) configuration may be pre-defined (e.g., a fixed positive integer value).

In some implementations, during the subsequent cell switches, the UE may not need to perform the UL synchronization to acquire the TA values of the target cell(s). The UE may (by default) perform the RACH-less LTM procedure.

In some implementations, during the subsequent cell switches, the UE may determine whether to perform the UL synchronization to acquire the TA values of the target cell(s) based on the content of the received cell switch command (or based on a MAC CE for a subsequent cell switch command). If the UE determines to perform the UL synchronization to acquire the TA values of the target cell(s), the UE may perform the PDCCH-ordered RA procedure with RAR, PDCCH-ordered RA procedure without RAR, and/or UE-based TA measurement with the target cell(s) and/or the source cell. If the UE determines not to perform the UL synchronization to acquire the TA values of the target cell(s), the UE may perform the RACH-less LTM procedure with the target cell.

For example, if the indication in the received cell switch command (or a MAC CE for subsequent cell switch command) indicates that the TA value of the target cell(s) is zero, the TA values indicating that the UE should apply the same TA value as that of the source serving cell compared to the target cell(s) in the subsequent cell switch, or the TA values indicating the UE should apply the same TA value as that of the source serving cell from which the UE receives the RRC Reconfiguration message during the RRC reconfiguration phase, the UE may determine not to acquire the TA values for the target cell in the subsequent cell switch.

The indication may include multiple bits to represent the TA values. The indication may include a Boolean format or ENUMERATED format (e.g., a first value in the ENUMERATED format may represent that the TA value of the target cell(s) is zero, a second value in the ENUMERATED format may represent that the TA values indicating the UE should apply the same TA value as that of the source serving cell compared to the target cell(s) in the subsequent cell switch, and a third value in the ENUMERATED format may represent the TA values indicating the UE should apply the same TA value as that of the source serving cell from which the UE receives the RRC Reconfiguration message during the RRC reconfiguration phase).

In some implementations, if one of the following conditions (a)-(e) is satisfied, the UE may determine not to acquire the TA values for the target cell in the subsequent cell switch.
(a) the indication is represented by multiple consecutive bit 1(s),
(b) the indication is represented by multiple consecutive bit 0(s),
(c) the indication is represented by an ENUMERATED value that indicates that the TA value of the target cell(s) is zero,
(d) the indication is represented by an ENUMERATED value indicating the TA values that indicate that the UE should apply the same TA value as that of the source serving cell compared to the target cell(s) in the subsequent cell switch, and
(e) the indication is represented by an ENUMERATED value indicating the TA values that indicate that the UE should apply the same TA value as that of the source serving cell from which the UE receives the RRC Reconfiguration message during the RRC reconfiguration phase. In some implementations, if the indication is represented by multiple consecutive bit 1(s), by multiple consecutive bit 0(s), and/or by an ENUMERATED value representing an absent value, the UE may determine to acquire the TA values for the target cell in the subsequent cell switch.

In some implementations, during the subsequent cell switches, the UE may determine whether to perform the UL synchronization to acquire the TA values of the target cell(s) based on a timer. If the timer expires before/while the UE receives the cell switch command for the subsequent cell switch (e.g., this condition may represent that the UE determines to perform the UL synchronization to acquire the TA values of the target cell(s)), the UE may perform the PDCCH-ordered RA procedure with RAR, PDCCH-ordered RA procedure without RAR, and/or UE-based TA measurement, with the target cell(s) and/or the source cell. If the timer is running when the UE receives the cell switch command for the subsequent cell switch (e.g., this condition may represent that the UE determines not to perform the UL synchronization to acquire the TA values of the target cell(s)), the UE may perform the RACH-less LTM procedure with the target cell.

In some implementations, the UE may receive the (initial/maximum) timer value for the timer in an RRC Reconfiguration message during the RRC pre-configuration phase, in the cell switch command MAC CE, in the cell switch command MAC CE for the subsequent cell switch, and/or in the candidate cell TCI states activation/deactivation MAC CE.

In some implementations, an information element may be in an ENUMERATED format in the RRC Reconfiguration message and the values in the ENUMERATED format may represent one or more (initial/maximum) timer values. Thus, the UE may determine the timer value based on the received values in the information element.

In some implementations, one or more combinations of multiple bits in the bit fields of the cell switch command MAC CE, in the cell switch command MAC CE for the subsequent cell switch, and/or in the candidate cell TCI states activation/deactivation MAC CE may correspond to multiple defined (initial/maximum) timer values. For example, if there are three bits, ‘111’ may represent one defined (initial/maximum) timer value and ‘110’ may represent another defined (initial/maximum) timer value. The mapping between the one or more combinations of multiple bits and the one or more (initial/maximum) timer values may be predefined or provided to the UE via an RRC message (e.g., the RRC Reconfiguration message during the RRC pre-configuration phase).

In some implementations, the UE may (re) set the timer with the received initial/maximum timer value when the UE receives the timer value, when the UE determines to perform the subsequent cell switch, and/or when the UE performs the (subsequent) cell switch successfully (e.g., the UE successfully receives the DL data and/or transmits the UL data with the target cell). After/when the UE (re) sets the timer, the UE may (immediately) start the timer. In some implementations, the UE may start the timer (immediately) after/when the UE receives the timer value.

In some implementations, the UE may stop the timer when the UE exists/completes the LTM procedure and/or when the TA timer corresponding to the TA of the target cell and/or the source cell expires. In some implementations, the UE may operate (e.g., start, (re) set, stop, determine the timer status) the timer on a procedure basis (e.g., the timer is common to all cells involved in the LTM procedure). For example, the UE may stop the timer when completing the LTM procedure. In some implementations, the UE may operate (e.g., start, (re) set, stop, determine the timer status) the timer per cell (e.g., per candidate target cell, per target cell, per source cell) basis. For example, the UE may stop the timer when determining that the TA timer corresponding to the TA of the target cell and/or the source cell expires.

In some implementations, the UE may maintain the timer in the RRC layer of the UE. when the timer expires, is stopped, is (re) set, and/or is started, the RRC layer of the UE may notify the MAC entity of the UE. Thus, the MAC entity of the UE may perform the corresponding TA acquisition, if necessary (or if the UE determines to do so).

In some implementations, during the subsequent cell switches, the UE may determine whether to perform the UL synchronization to acquire the TA values of the target cell(s) based on a counter. If the counter reaches a maximum value or reaches zero before/when the UE receives the cell switch command for the subsequent cell switch (e.g., this condition may represent that the UE determines to perform the UL synchronization to acquire the TA values of the target cell(s)), the UE may perform the PDCCH-ordered RA procedure with RAR, PDCCH-ordered RA procedure without RAR, and/or UE-based TA measurement, with the target cell(s) and/or the source cell. If the counter has not yet reached a maximum value or not yet reached zero when the UE receives the cell switch command for the subsequent cell switch (e.g., this condition may represent that the UE determines not to perform the UL synchronization to acquire the TA values of the target cell(s)), the UE may perform the RACH-less LTM procedure with the target cell.

In some implementations, the UE may receive the maximum counter value for the counter in an RRC Reconfiguration message during the RRC pre-configuration phase, in the cell switch command MAC CE, in the cell switch command MAC CE for the subsequent cell switch, and/or in the candidate cell TCI states activation/deactivation MAC CE.

In some implementations, an information element may be in an ENUMERATED format in the RRC Reconfiguration message and the values in the ENUMERATED format may represent one or more maximum counter values. Thus, the UE may determine the counter value based on the received values in the information element.

In some implementations, one or more combinations of multiple bits in the bit fields of the cell switch command MAC CE, in the cell switch command MAC CE for the subsequent cell switch and/or in the candidate cell TCI states activation/deactivation MAC CE may correspond to multiple defined maximum counter values. For example, if there are three bits, ‘111’ may represent one defined maximum counter value and ‘110’ may represent another defined maximum counter value. The mapping between the one or more combinations of multiple bits and the one or more maximum counter values may be predefined or provided to the UE via an RRC message (e.g., the RRC Reconfiguration message during the RRC pre-configuration phase).

In some implementations, the UE may (re) set the counter with the received maximum counter value (or (re) set the counter to zero) when the UE receives the counter value, when the UE determines to perform the subsequent cell switch, and/or when the UE performs the (subsequent) cell switch successfully (e.g., the UE successfully receives the DL data and/or transmits the UL data with the target cell).

In some implementations, the UE may decrease (or increase) the counter by one when the UE performs a cell switch to a target cell successfully and/or when the UE (re) acquires the TA of the source cell and/or the target cells.

In some implementations, the UE may stop the counter when the UE exists/completes the LTM procedure and/or when the TA timer corresponding to the TA of the target cell and/or the source cell expires. In some implementations, the UE may operate (e.g., (re) set, stop, increment, decrease, determine the counter status) the counter on a procedure basis (e.g., the counter is common to all cells involved in the LTM procedure). For example, the UE may stop the counter when completing the LTM procedure. In some implementations, the UE may operate (e.g., (re) set, stop, increment, decrease, determine the counter status) the counter per cell (e.g., per candidate target cell, per target cell, per source cell) basis. For example, the UE may stop the counter when determining that the TA timer corresponding to the TA of the target cell and/or source cell has expired.

In some implementations, the UE may maintain the counter in the MAC layer of the UE. When the counter reaches zero, reaches the maximum value, is stopped, is (re) set, and/or is started, the MAC layer of the UE may notify the RRC entity of the UE. Thus, the RRC layer of the UE may perform the corresponding TA acquisition and/or request the source cell to reconfigure the TA related configuration (e.g., via transmitting an RRC connection setup request message to the source/target cell, via transmitting an RRC reestablishment request message to the source/target cell), if necessary (or if the UE determines to do so).

In some implementations, during the subsequent cell switches, if the UE does not receive the (initial/maximum) timer value or the maximum counter value, the UE may determine whether to perform the UL synchronization to acquire the TA values of the target cell(s) based on the content of the received cell switch command (or a MAC CE for a subsequent cell switch command). For example, the UE may determine to perform the UL synchronization (e.g., by acquiring the TA values of the target cell(s)) if the received MAC CE for the (subsequent) cell switch command includes some bits that indicate to the UE to acquire the TA values of the target cell(s). For example, the UE may determine not to perform the UL synchronization (e.g., by acquiring the TA values of the target cell(s)) if the received MAC CE for the (subsequent) cell switch command includes some bits that indicate to the UE to perform the RACH-less LTM procedure for the subsequent cell switches.

In some implementations, during the subsequent cell switches, if the UE does not receive the (initial/maximum) timer value or the maximum counter value, the UE may determine not to perform the UL synchronization to acquire the TA values of the target cell(s). The UE may (by default) perform the RACH-less LTM procedure for the subsequent cell switches.

In some implementations, during the subsequent cell switches, if the UE is not configured with the (initial/maximum) timer value or the maximum counter value, the UE may determine not to perform the UL synchronization to acquire the TA values of the target cell(s). The UE may (by default) perform the RACH-less LTM procedure for the subsequent cell switches.

In some implementations, if the timer expires and the UE has not received the cell switch command for the subsequent cell switch, the RRC layer of the UE may notify the MAC layer of the UE of the TA expiration issue (or the UL asynchronization (out of sync) issue).

In some implementations, after/when the UE receives the cell switch command for the subsequent cell switch, the UE may determine the timer status and/or the counter status if the timer value and/or counter value is configured. Thus, before the UE receives the cell switch command for the subsequent cell switch and the timer expires, the UE may ignore the timer expiration. The UE may perform the corresponding actions as presented in the implementations of the present disclosure when the UE receives the cell switch command for the subsequent cell switch based on the determination of the timer status and/or the counter status.

In some implementations, if the UE is already configured with the counter, and afterwards, if the UE receives or is configured with the timer, the UE may ignore, reset, or stop the counter. The UE may determine the subsequent cell switch and/or the TA acquisition for the subsequent cell switch based on the timer rather than the counter.

In some implementations, if the UE is already configured with the timer, and afterwards, if the UE receives or is configured with the counter, the UE may ignore, reset, or stop the timer. The UE may determine the subsequent cell switch and/or the TA acquisition for the subsequent cell switch based on the counter rather than the timer.

In some implementations, once the UE completes the cell switch to the selected target cell, the UE may transmit an indicator to the selected target cell (e.g., hybrid automatic repeat request-Acknowledgement (HARQ-ACK) information, or ACK) to indicate the successful completion of the LTM cell switch to the selected target cell. The indicator may be included in an RRC message transmitted by the UE to the selected target cell. The indicator may be included in the lower layer signaling (e.g., the UCI, HARQ ACK/Negative-Acknowledgement (NACK)) transmitted by the UE to the selected target cell.

In some implementations, once the UE completes the cell switch to the selected target cell, the UE may transmit an indicator to the source gNB/cell to indicate the successful completion of the LTM cell switch to the selected target cell. The indicator may be included in an RRC message transmitted by the UE to the source gNB/cell. The indicator may be included in the lower layer signaling (e.g., UCI, HARQ ACK/NACK) transmitted by the UE to the source gNB/cell. For example, the UE may transmit an ACK once the UE successfully completes the cell switch to the target cell. The HARQ-ACK (e.g., ACK/NACK) may be transmitted by the UE via UCI, for example, in either a PUCCH or a PUCCH multiplexed with the PUSCH, to the source gNB/cell. In some implementations, the indicator may include a bit having the value ‘1’, and the value ‘1’ may represent that the UE has successfully completed the cell switch to the target cell. In some implementations, the indicator may include a bit having the value ‘0’, and the value ‘0’ may represent that the UE has successfully completed the cell switch to the target cell.

In some implementations, once the UE determines that the cell switch to the target cell has failed, the UE may transmit an indicator (e.g., the HARQ-ACK information or NACK) to the source gNB/cell to indicate the unsuccessful completion of the LTM cell switch to the selected target cell. The indicator may be included in an RRC message transmitted by the UE to the source gNB/cell. The indicator may be included in the lower layer signaling (e.g., UCI, HARQ ACK/NACK) transmitted by the UE to the source gNB/cell. For example, the UE may transmit a NACK once the UE fails to complete the cell switch to the target cell. The HARQ-ACK (e.g., ACK/NACK) may be transmitted by the UE, via UCI, for example, in either a PUCCH or a PUCCH multiplexed with the PUSCH, to the source gNB/cell. In some implementations, the indicator may include a bit having the value ‘1’, and the value ‘1’ may represent that the UE has failed to successfully complete the cell switch to the target cell. In some implementations, the indicator may include a bit having the value ‘0’, and the value ‘0’ may represent that the UE has failed to successfully complete the cell switch to the target cell.

In some implementations, a UE may transmit an indicator (e.g., a success indicator or an unsuccess indicator) to the selected target cell or the source gNB/cell to indicate whether the LTM cell switch to the selected target cell has been successful or not. The UE may transmit a successful indicator (e.g., via the HARQ-ACK information, ACK, a MAC CE including one or more field(s) used to indicate that the LTM cell switch is successful) to the selected target cell to indicate the successful completion of the LTM cell switch to the selected target cell. The UE may transmit an unsuccessful indicator (e.g., via the HARQ-ACK information, NACK, a MAC CE including one or more field(s) used to indicate that the LTM cell switch is unsuccessful, a MAC CE including one or more field(s) indicating the UE to fallback to the L3 HO) to the source gNB/cell to indicate the unsuccessful completion of the LTM cell switch to the selected target cell.

### Different LTM Scenarios

Multiple scenarios may be supported by the LTM. For example, the LTM scenarios (e.g., the scenarios supported by the LTM) may include, but are not limited to, the intra-gNB-distributed unit (DU) (e.g., the intra-central unit (CU) intra-DU) mobility, inter-gNB-DU (e.g., inter-CU inter-DU) mobility, inter-frequency mobility, PCell change in non-CA scenario, PCell change without SCell change in carrier aggregation (CA) scenario, and PCell change with SCell changes in CA scenario. The LTM scenarios may include the following three cases: (1) the target PCell/target SCell(s) is not a current serving cell (CA-to-CA scenario with PCell change), (2) the target PCell is a current SCell, and (3) the target SCell is the current PCell, and a dual connectivity scenario (e.g., at least for the PSCell change without the MN involvement case, (e.g., intra-secondary node (SN))).

For intra-gNB-DU mobility, the UE may switch from the source cell to the selected target cell, and the source cell and the selected target cell may belong to the same CU and the same DU within a gNB. The UE may apply the same PHY layer of the UE for the source cell and for the selected target cell. The UE may apply the same MAC layer of the UE for the source cell and for the selected target cell. The UE may apply the same RLC layer of the UE for the source cell and for the selected target cell. The UE may apply the same PDCP layer of the UE for the source cell and for the selected target cell. The UE may apply the same RRC layer of the UE for the source cell and for the selected target cell.

### Initialization of the PDCCH Order Early RACH to an LTM Candidate Cell

In some implementations, the RA procedure on an SCell or on an LTM candidate cell may (only) be initiated by a PDCCH order with the ra-PreambleIndex different from 0b000000 (e.g., value ‘0’), the ra-PreambleIndex configured as a particular value for an LTM candidate cell, or the ra-PreambleIndex configured as a particular value for the LTM procedure. For example, the UE may initiate an RA procedure on an LTM candidate cell when the UE receives the PDCCH order from the source cell. The ra-PreambleIndex may be a parameter configured by the RRC or by the DCI for the selected set of RA resources, and may be also known as the RA preamble. The value of the ra-PreambleIndex may be from 0 to 63. In some implementations, one or more ra-PreambleIndex value(s) may be configured as the particular value(s) for an LTM candidate cell or the particular value(s) for the LTM procedure. In some implementations, some ra-PreambleIndex values (e.g., from the ra-PreambleIndex 1 to 31) may be configured as the particular values for the LTM candidate target cells and/or LTM procedures in the RRC pre-configuration. After the UE receives the RRC pre-configuration from the source gNB/cell, if the UE receives the PDCCH order indicating one of the particular values, the UE may perform the RA procedure with the corresponding candidate target cell and/or may perform the RA procedure for the LTM.

In some implementations, when the RA procedure is initiated with an LTM candidate cell, the MAC entity of the UE may perform at least one of the following actions (1)-(24):
(1) flush the Msg 3 buffer,
(2) flush the Msg 3 buffer, where the Msg 3 buffer is used for an LTM procedure,
(3) flush the Msg 3 buffer, in which the Msg 3 buffer is used for the LTM candidate cell indicated by the PDCCH order,
(4) flush the Msg 3 buffer, in which the Msg 3 buffer is not used for the LTM procedure, the Msg 3 buffer is not used for the LTM candidate cell indicated by the PDCCH order, and/or the UE does not expect to transmit the Msg 3 to the source cell and/or the LTM candidate target cell indicated by the PDCCH order or by the cell switch command,
(5) flush the MSGA buffer,
(6) flush the MSGA buffer, in which the MSGA buffer is used for an LTM procedure,
(7) flush the MSGA buffer, in which the MSGA buffer is used for the LTM candidate cell indicated by the PDCCH order,
(8) flush the MSGA buffer, in which the MSGA buffer is not used for the LTM procedure and is not used for the LTM candidate cell indicated by the PDCCH order,
(9) set the PREAMBLE_LTM_CANDIDATE_CELL_TRANSMISSION_COUNTER to 1, in which the PREAMBLE_LTM_CANDIDATE_CELL_TRANSMISSION_COUNTER is a UE variable used for the RA procedure on an LTM candidate cell and/or is associated with the LTM candidate cell indicated by the PDCCH order,
(10) set the PREAMBLE_LTM_TRANSMISSION_COUNTER to 1, in which the PREAMBLE_LTM_TRANSMISSION_COUNTER is a UE variable used for RA procedure for the LTM procedure,
(11) set the PREAMBLE_LTM_CANDIDATE_CELL_TRANSMISSION_COUNTER to 1 when/if the RA procedure is initiated by the PDCCH order for an LTM candidate cell and the PDCCH order indicates a preamble initial transmission,
(12) set the PREAMBLE_LTM_CANDIDATE_CELL TRANSMISSION_COUNTER to 1 when/if the UE receives the PDCCH order including one bit (e.g., a Boolean indicator ‘1’ or ‘0’) that indicates the UE to perform a preamble initial transmission to the LTM candidate cell,
(13) set the PREAMBLE_LTM_TRANSMISSION_COUNTER to 1 when/if the RA procedure is initiated by the PDCCH order for the LTM procedure and the PDCCH order indicates a preamble initial transmission,
(14) set the PREAMBLE_LTM_TRANSMISSION_COUNTER to 1 when/if the UE receives the PDCCH order including one bit (e.g., a Boolean indicator ‘1’ or ‘0’) that indicates the UE to perform a preamble initial transmission for the LTM procedure,
(15) set the PREAMBLE_LTM_CANDIDATE_CELL POWER_RAMPING_COUNTER to 1, in which the PREAMBLE_LTM_CANDIDATE_CELL_POWER_RAMPING_COUNTER is a UE variable used for the RA procedure on an LTM candidate cell and/or is associated with the LTM candidate cell indicated by the PDCCH order,
(16) set the PREAMBLE_LTM_POWER_RAMPING_COUNTER to 1, in which the PREAMBLE_LTM_POWER_RAMPING_COUNTER is a UE variable used for the RA procedure on an LTM candidate cell and/or is associated with the LTM candidate cell indicated by the PDCCH order,
(17) select the normal uplink (NUL) carrier of the LTM candidate cell for performing the RA procedure on the LTM candidate cell (e.g., by default even though the LTM candidate cell is configured with NUL and supplementary uplink (SUL) carrier),
(18) determine that the LTM candidate cell is configured with NUL and SUL, and select SUL of the LTM candidate cell for performing the RA procedure on the LTM candidate cell,
(19) determine the RSRP of the downlink pathloss reference of the LTM candidate cell (e.g., during the DL synchronization step),
(20) determine that the RSRP of the downlink pathloss reference of the LTM candidate cell is less than (or equal to) a threshold (e.g., the rsrp-ThresholdSSB-SUL, rsrp-ThresholdSSB-LTM-SUL), and select the SUL carrier of the LTM candidate cell for performing the RA procedure on the LTM candidate cell,
(21) determine that the RSRP of the downlink pathloss reference of the LTM candidate cell is higher than (or equal to) a threshold (e.g., the rsrp-ThresholdSSB-SUL, rsrp-ThresholdSSB-LTM-SUL), and select the NUL carrier of the LTM candidate cell for performing the RA procedure on the LTM candidate cell,
(22) select the initial (UL) BWP of the LTM candidate cell for the RA procedure,
(23) select an LTM-specific UL BWP of the LTM candidate cell for the RA procedure, and/or
(24) perform the RA resource selection procedure for the RA procedure of (on) the LTM candidate cell.

The LTM candidate cell may be indicated to the UE by the PDCCH order transmitted from the source cell to the UE. The PDCCH order may include the index of the LTM candidate cell, the PCI of the LTM candidate cell, the cell ID of the LTM candidate cell, the index of the LTM candidate cell configuration, to indicate the LTM candidate cell. The index of the LTM candidate cell configuration may be associated with an LTM candidate cell (e.g., the cell ID, PCI, and/or index of the LTM candidate cell is included in the LTM candidate cell configuration). The UE may receive the RRC Reconfiguration message including the LTM candidate cell configuration(s) from the source cell. The UE may be configured with the LTM candidate cell configuration(s) when/upon receiving the RRC Reconfiguration message including the LTM candidate cell configuration(s) (e.g., during the RRC pre-configuration phase).

In some implementations, when the UE performs the RA procedure on the LTM candidate cell, the UE may not transmit the Msg3 to the LTM candidate cell. Thus, the UE may not be configured with the Msg3 buffer. In some implementations, even though the UE is configured with the Msg3 buffer, when the UE performs the RA procedure on the LTM candidate cell, the UE may flush the Msg3 buffer, because the UE does not transmit the Msg3 to the LTM candidate cell. In some implementations, the UE may flush the Msg3 buffer, because the UE does not transmit the Msg3 to the source cell and does not transmit the Msg3 to the LTM candidate cell.

In some implementations, when the UE performs the RA procedure on the LTM candidate cell, the UE may be configured with an Msg3 buffer specifically used for the LTM candidate cell. Thus, the UE may flush the Msg3 buffer that is specifically used for the LTM candidate cell when the UE initiates the PDCCH-ordered early RACH for the LTM candidate cell. The UE may transmit the Msg3 to the LTM candidate cell during the LTM procedure.

In some implementations, when the UE performs the RA procedure on the LTM candidate cell, the UE may be configured with an Msg3 buffer specifically used for the LTM procedure. Thus, the UE may flush the Msg3 buffer specifically used for the LTM procedure when the UE initiates the PDCCH-ordered early RACH for the LTM procedure. The UE may transmit the Msg3 to at least one LTM candidate cell during the LTM procedure. During the LTM procedure, the UE may perform the RA procedure(s) (simultaneously) with at least one LTM candidate cell.

In some implementations, when the UE performs the RA procedure on the LTM candidate cell, the UE may not be configured with an Msg3 buffer specifically used for the LTM candidate cell and/or may not be configured with an Msg3 buffer specifically used for the LTM procedure. However, the UE may still be configured with an Msg3 buffer used for the legacy RA procedure. Since the UE does not perform the RA procedure on the LTM candidate cell and the legacy RA procedure (e.g., on the SCell or on the source cell) simultaneously, the UE may flush the Msg3 buffer.

In some implementations, the UE may perform a 2-step RA procedure on the LTM candidate cell. Thus, the UE may flush the MSGA buffer, especially for the LTM candidate cell, when the PDCCH-ordered (2-step) early RACH is initiated for the LTM candidate cell.

In some implementations, the UE may already be configured with a legacy 2-step RA procedure. However, the UE may not perform the 2-step RA procedure on the LTM candidate cell, may not perform the 2-step RA procedure for the LTM procedure, may not perform the RA procedure on the LTM candidate cell, and/or may not perform the RA procedure for the LTM procedure simultaneously with the legacy 2-step RA procedure. Thus, the UE may flush the MSGA buffer, especially for the legacy 2-step RA procedure, when the UE initiates the PDCCH-ordered early RACH to the LTM candidate cell and/or for the LTM procedure.

In the present disclosure, in addition to applying the RSRP of the downlink pathloss reference of the LTM candidate cell for the determination (e.g., the determination may include a determination of whether to perform a 4-step RA procedure, a determination of whether to perform a 2-step RA procedure, a determination of whether to transmit a beam report to the source cell, and/or a determination of whether to perform a cell switch to the corresponding LTM candidate cell), the UE may apply the RSRQ, SINR, and/or RSSI of the downlink pathloss reference of the LTM candidate cell for the determination (e.g., the determination may include a determination of whether to perform a 4-step RA procedure, a determination of whether to perform a 2-step RA procedure, a determination of whether to transmit a beam report to the source cell, and/or a determination of whether to perform a cell switch to the corresponding LTM candidate cell). Thus, the threshold values in some implementations may include the rsrq-ThresholdSSB-SUL, rsrq-ThresholdSSB-LTM-SUL, sinr-ThresholdSSB-SUL, sinr-ThresholdSSB-LTM-SUL, rssi-ThresholdSSB-SUL, and/or rssi-ThresholdSSB-LTM-SUL.

The reference signals used for the RSRP/RSRQ/SINR/RSSI measurement of the downlink (pathloss) reference of the LTM candidate cell may include, but are not limited to, the SSB, CSI-RS, and TRS. Thus, the threshold values in some implementations may include the rsrp-ThresholdCSI-RS-SUL, rsrp-ThresholdCSI-RS-LTM-SUL, rsrq-ThresholdCSI-RS-SUL, rsrq-ThresholdCSI-RS-LTM-SUL, sinr-ThresholdCSI-RS-SUL, sinr-ThresholdCSI-RS-LTM-SUL, rssi-ThresholdCSI-RS-SUL, rssi-ThresholdCSI-RS-LTM-SUL, rsrp-ThresholdTRS-SUL, rsrp-ThresholdTRS-LTM-SUL, rsrq-ThresholdTRS-SUL, rsrq-ThresholdTRS-LTM-SUL, sinr-ThresholdTRS-SUL, sinr-ThresholdTRS-LTM-SUL, rssi-ThresholdTRS-SUL, and/or rssi-ThresholdTRS-LTM-SUL. For example, the parameters ending with “-SUL” may include a parameter common for the SUL operation (e.g., the UL carrier selection for the initial access, UL carrier selection for the handover, UL carrier selection for the LTM). As another example, the parameters ending with “-LTM-SUL” may include a parameter specific to the UL carrier selection for the LTM.

In some implementations, the UE may receive the thresholds in the SIB1 of the source cell for determining whether to perform the RA procedures with the LTM candidate cell on the SUL or NUL of the LTM candidate cell. In some implementations, the UE may receive the RRC Reconfiguration message including the thresholds from the source cell (e.g., during the RRC pre-configuration phase). The thresholds may be included in (or be associated with) the SUL related IEs in the RRC Reconfiguration message and/or the SIB1. The thresholds may be included in (or be associated with) the LTM related IEs in the RRC Reconfiguration message and/or the SIB1.

The UE may receive the SIB1 of the source cell and/or RRC Reconfiguration message from the source cell (e.g., during the RRC pre-configuration phase), and the SIB1 and/or the RRC Reconfiguration message may include the LTM-specific UL BWP configuration.

### Random Access Preamble Transmission to the LTM Candidate Cell

In some implementations, the MAC entity of the UE may, for each (selected) RA preamble to be transmitted to the LTM candidate cell, perform at least one of the following actions (1)-(12):
(1) increment the PREAMBLE_LTM_CANDIDATE_CELL_POWER_RAMPING_COUNTER by 1 when/if the RA procedure is initiated by the PDCCH order for an LTM candidate cell and the PDCCH order indicates a preamble re-transmission, when/if the PREAMBLE_LTM_CANDIDATE_CELL TRANSMISSION_COUNTER (or the PREAMBLE_LTM_TRANSMISSION_COUNTER) is greater than one, when/if the MAC entity of the UE does not receive the notification to suspend the power ramping counter (e.g., especially for the LTM candidate cell or especially for the LTM procedure) from lower layers, and/or when/if the downlink reference signal (e.g., the SSB, the CSI-RS, the TRS, or the reference signal used for the DL synchronization) selected for the RA preamble transmission is the same as the downlink reference signal that was used in the last/previous RA preamble transmission to the LTM candidate cell (or for the LTM procedure),
(2) increment the PREAMBLE_LTM_CANDIDATE_CELL_POWER_RAMPING_COUNTER by 1 when/if the UE receives the PDCCH order including a bit (e.g., a Boolean indicator ‘1’ or ‘0’) indicating the UE to perform a preamble re-transmission (e.g., a re-transmission of the PRACH) to the LTM candidate cell, when/if the PREAMBLE_LTM_CANDIDATE_CELL_TRANSMISSION_COUNTER (or the PREAMBLE_LTM_TRANSMISSION_COUNTER) is greater than one, when/if the MAC entity of the UE does not receive the notification to suspend the power ramping counter (e.g., especially for the LTM candidate cell or especially for the LTM procedure) from lower layers, and/or when/if the downlink reference signal (e.g., the SSB, the CSI-RS, the TRS, or the reference signal used for the DL synchronization) selected for the RA preamble transmission is the same as the downlink reference signal that was used in the last/previous RA preamble transmission to the LTM candidate cell (or for the LTM procedure),
(3) increment the PREAMBLE_LTM_POWER_RAMPING_COUNTER by 1 when/if the RA procedure is initiated by the PDCCH order for the LTM procedure and the PDCCH order indicates a preamble re-transmission, when/if the PREAMBLE_LTM_CANDIDATE_CELL_TRANSMISSION_COUNTER (or the PREAMBLE_LTM_TRANSMISSION_COUNTER) is greater than one, when/if the MAC entity of the UE does not receive the notification suspend the power ramping counter (e.g., especially for the LTM candidate cell or especially for the LTM procedure) from lower layers, and/or when/if the downlink reference signal (e.g., the SSB, the CSI-RS, the TRS, or the reference signal used for the DL synchronization) selected for the RA preamble transmission is the same as the downlink reference signal that was used in the last/previous RA preamble transmission to the LTM candidate cell (or for the LTM procedure),
(4) increment the PREAMBLE_LTM_POWER_RAMPING_COUNTER by 1 when/if the UE receives the PDCCH order including a bit (e.g., a Boolean indicator ‘1’ or ‘0’) indicating the UE to perform a preamble re-transmission (e.g., a re-transmission of the PRACH) to the LTM candidate cell, when/if the PREAMBLE_LTM_CANDIDATE_CELL_TRANSMISSION_COUNTER (or the PREAMBLE_LTM_TRANSMISSION_COUNTER) is greater than one, when/if the MAC entity of the UE does not receive the notification to suspend the power ramping counter (e.g., especially for the LTM candidate cell or especially for the LTM procedure) from lower layers, and/or when/if the downlink reference signal (e.g., the SSB, CSI-RS, TRS, reference signal used for the DL synchronization) selected for the RA preamble transmission is the same as the downlink reference signal that was used in the last/previous RA preamble transmission to the LTM candidate cell (or for the LTM procedure),
(5) set the PREAMBLE_RECEIVED_TARGET_POWER (e.g., especially for the preamble transmission on the LTM candidate cell or especially for the preamble transmission for the LTM procedure) to preambleReceivedTargetPower+DELTA PREAMBLE+(PREAMBLE_POWER_RAMPING_COUNTER (e.g., PREAMBLE_LTM_POWER_RAMPING_COUNTER or PREAMBLE_LTM_CANDIDATE_CELL POWER_RAMPING_COUNTER)−1)×PREAMBLE_POWER_RAMPING_STEP+POWER_OFFSET_2STEP_RA,
(6) instruct the physical layer to transmit the RA preamble to the LTM candidate cell using the selected PRACH occasion, the corresponding RA-RNTI (if available), the corresponding C-RNTI (e.g., for the LTM candidate cell), the PREAMBLE_INDEX, and the PREAMBLE_RECEIVED_TARGET_POWER (e.g., determined based on the PREAMBLE_LTM_POWER_RAMPING_COUNTER or the PREAMBLE_LTM_CANDIDATE_CELL_POWER_RAMPING_COUNTER),
(7) increment the PREAMBLE_LTM_CANDIDATE_CELL_TRANSMISSION_COUNTER by 1 when/if the RA procedure is initiated by the PDCCH order for an LTM candidate cell and the PDCCH order indicates a preamble re-transmission, when/if the UE receives the PDCCH order including a bit (e.g., a Boolean indicator ‘1’ or ‘0’) indicating the UE to perform a preamble re-transmission (e.g., a re-transmission of the PRACH) to the LTM candidate cell, when/if the UE does not receive the cell switch command (e.g., the cell switch command may include the TA value of the LTM candidate cell) from the source cell and a timer for the preamble transmission associated with the LTM candidate cell expires, and/or when/if the UE receives the cell switch command with the absent TA values of the LTM candidate cell,
(8) increment the PREAMBLE_LTM_TRANSMISSION_COUNTER by 1 when/if the RA procedure is initiated by the PDCCH order for the LTM procedure and the PDCCH order indicates a preamble re-transmission, when/if the UE receives the PDCCH order including a bit (e.g., a Boolean indicator ‘1’ or ‘0’) indicating the UE to perform a preamble re-transmission (e.g., a re-transmission of the PRACH) for the LTM procedure, when/if the UE does not receive the cell switch command (e.g., the cell switch command may include the TA value of the LTM candidate cell) from the source cell and a timer for the preamble transmission associated with the LTM candidate cell expires, and/or when/if the UE receives the cell switch command with the absent TA values of the LTM candidate cell,
(9) indicate, to the upper layer (e.g., the RRC layer of the UE), the RA problem on the LTM candidate cell when/if the PREAMBLE_LTM_CANDIDATE_CELL TRANSMISSION_COUNTER reaches a maximum value (e.g., the preambleTransMax+1) and/or when/if the RA preamble is transmitted on the LTM candidate cell,
(10) indicate, to the upper layer (e.g., the RRC layer of the UE), the RA problem for the LTM procedure when/if the PREAMBLE_LTM_CANDIDATE_CELL_TRANSMISSION_COUNTER reaches a maximum value (e.g., the preambleTransMax+1) and/or when/if the RA preamble is transmitted on the LTM candidate cell,
(11) determine that the RA procedure on the LTM candidate cell and/or for the LTM procedure is unsuccessfully completed when/if the PREAMBLE_LTM_CANDIDATE_CELL_TRANSMISSION_COUNTER reaches a maximum value (e.g., the preambleTransMax+1), when/if the RA preamble is transmitted on the LTM candidate cell, and/or if the RA procedure was triggered for the (early) TA acquisition for the LTM procedure, and
(12) perform the RA resource selection procedure (e.g., especially for the LTM candidate cell or especially for the LTM procedure) when/if the PREAMBLE_LTM_CANDIDATE_CELL_TRANSMISSION_COUNTER does not reach a maximum value (e.g., the preambleTransMax+1), when/if the RA preamble is transmitted on the LTM candidate cell, and/or when/if the RA procedure on the LTM candidate cell and/or for the LTM procedure is not completed.

In some implementations, the PREAMBLE_RECEIVED_TARGET_POWER (e.g., especially for the preamble transmission on the LTM candidate cell, especially for the preamble transmission in the LTM procedure), DELTA_PREAMBLE, PREAMBLE_POWER_RAMPING_STEP, and POWER_OFFSET_2STEP_RA may be the UE variables used for the RA procedure for the LTM candidate cell and/or for the LTM procedure.

The UE may receive and/or be configured with the parameter preambleReceivedTargetPower (e.g., used for the preamble received target power for the preamble transmission to the LTM candidate cell, or used for the preamble received target power for the preamble transmission in the LTM procedure). The UE may receive the RRC Reconfiguration message including the parameter preambleReceivedTargetPower from the source cell during the RRC pre-configuration phase. The UE may receive the SIB1 including the parameter preambleReceivedTargetPower from the source cell. In some implementations, the parameter preambleReceivedTargetPower may be included in (or be associated with) the LTM candidate cell configuration. The parameter preambleReceivedTargetPower for the LTM procedure may be common to all LTM candidate cells or may be specific to the corresponding LTM candidate cell. In some implementations, if the UE is configured with the LTM candidate cell configuration for the initial/active (UL) BWP of the selected uplink carrier (e.g., the NUL, SUL) of the LTM candidate cell, the UE may apply the parameter preambleReceivedTargetPower configured in the LTM candidate cell configuration.

The UE may receive and/or be configured with the parameter indicating the maximum value (e.g., the preambleTransMax+1) or preambleTransMax (e.g., used for the preamble transmission counter for the LTM candidate cell, used for the preamble transmission counter for the LTM procedure). The UE may receive the RRC Reconfiguration message including the parameter indicating the maximum value (e.g., the preamble TransMax+1) or preambleTransMax from the source cell during the RRC pre-configuration phase. The UE may receive the SIB1 including the parameter indicating the maximum value (e.g., the preambleTransMax+1) or preambleTransMax from the source cell. In some implementations, the parameter indicating the maximum value (e.g., the preambleTransMax+1) or preambleTransMax may be included in (or be associated with) the LTM candidate cell configuration. The parameter indicating the maximum value (e.g., the preambleTransMax+1) or preambleTransMax for the LTM procedure may be common to all LTM candidate cells or may be specific to the corresponding LTM candidate cell. In some implementations, if the UE is configured with the LTM candidate cell configuration for the initial/active (UL) BWP of the selected uplink carrier (e.g., the NUL, SUL) of the LTM candidate cell, the UE may apply the parameter indicating the maximum value (e.g., the preambleTransMax+1) or preambleTransMax configured in the LTM candidate cell configuration.

The UE may determine that the PRACH transmission triggered by the PDCCH order is the initial transmission or the re-transmission based on a DCI field included in the PDCCH order. For example, if the DCI field included in the PDCCH order indicates ‘0,’ the PRACH transmission triggered by that PDCCH order may be the initial transmission. If the DCI field included in the PDCCH order indicates ‘1,’ the PRACH transmission triggered by that PDCCH order may be the re-transmission.

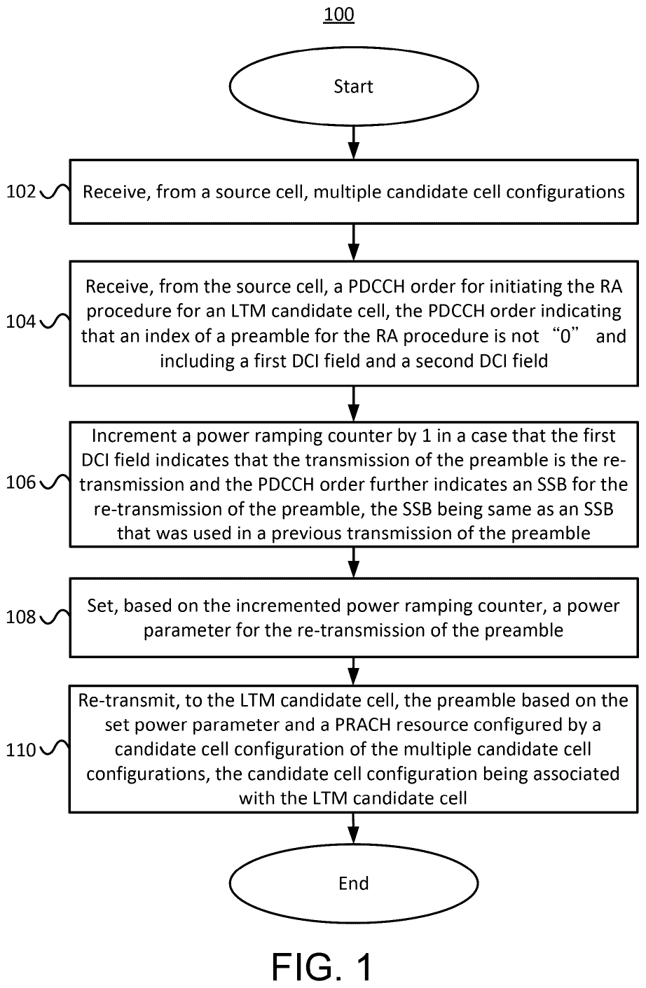

FIG. 1 is a flowchart illustrating a method/process 100 for performing, by a UE, an RA procedure for LTM, according to an example implementation of the present disclosure. Although actions 102, 104, 106, 108, and 110 are illustrated as separate actions represented as independent blocks in FIG. 1, these separately illustrated actions should not be construed as necessarily order-dependent. The order in which the actions are performed in FIG. 1 is not intended to be construed as a limitation, and any number of the disclosed blocks may be combined in any order to implement the method, or an alternate method. Moreover, each of actions 102, 104, 106, 108, and 110 may be performed independently of other actions, and can be omitted in some implementations of the present disclosure.

Process 100 may start, in action 102, by the UE receiving, from a source cell, multiple candidate cell configurations.

In action 104, the UE may receive, from the source cell, a PDCCH order for initiating the RA procedure for an LTM candidate cell. The PDCCH order may indicate that an index of a preamble for the RA procedure is not “0.” The PDCCH order may include a first DCI field indicating that a transmission of the preamble is an initial transmission or a re-transmission, and a second DCI field indicating the LTM candidate cell. In some implementations, the second DCI field may indicate the LTM candidate cell by indicating an index of the candidate cell configuration associated with the LTM candidate cell. In some implementations, the first DCI field may include a bit to indicate that the transmission of the preamble is the initial transmission or the re-transmission. For example, in a case that the bit is “0”, the bit indicates that the transmission of the preamble is the initial transmission, and in a case that the bit is “1”, the bit indicates that the transmission of the preamble is the re-transmission.

In action 106, the UE may increment a power ramping counter by 1 in a case that the first DCI field indicates that the transmission of the preamble is the re-transmission. The PDCCH order may further indicate an SSB for the re-transmission of the preamble for the LTM candidate cell. The SSB may be the same as an SSB that was used in a previous transmission of the preamble for the LTM candidate cell.

In action 108, the UE may set, based on the incremented power ramping counter, a power parameter for the re-transmission of the preamble.

In action 110, the UE may re-transmit, to the LTM candidate cell, the preamble based on the set power parameter and a PRACH resource configured by a candidate cell configuration of the multiple candidate cell configurations. The candidate cell configuration may be associated with the LTM candidate cell. Process 100 may then end.

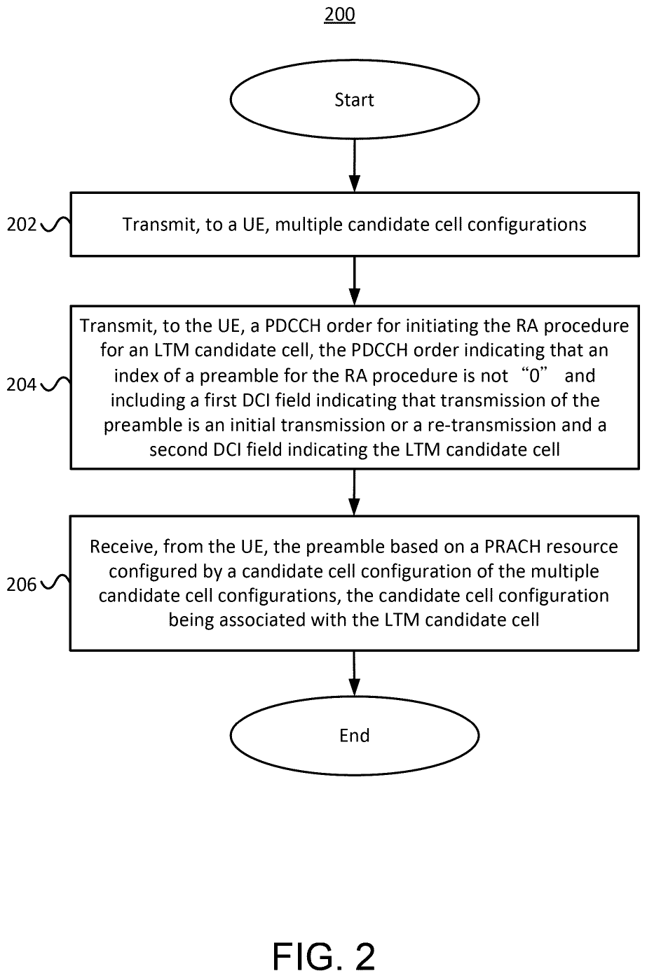

FIG. 2 is a flowchart illustrating a method/process 200 for performing, by a BS, an RA procedure for LTM, according to an example implementation of the present disclosure. Although actions 202, 204, and 206 are illustrated as separate actions represented as independent blocks in FIG. 2, these separately illustrated actions should not be construed as necessarily order-dependent. The order in which the actions are performed in FIG. 2 is not intended to be construed as a limitation, and any number of the disclosed blocks may be combined in any order to implement the method, or an alternate method. Moreover, each of actions 202, 204, and 206 may be performed independently of other actions, and can be omitted in some implementations of the present disclosure.

Process 200 may start, in action 202, by the BS transmitting, to a UE, multiple candidate cell configurations.

In action 204, the BS may transmit, to the UE, a PDCCH order for initiating the RA procedure for an LTM candidate cell. The PDCCH order may indicate that an index of a preamble for the RA procedure is not “0.” The PDCCH order may include a first DCI field indicating that a transmission of the preamble is an initial transmission or a re-transmission, and a second DCI field indicating the LTM candidate cell. In some implementations, the second DCI field may indicate the LTM candidate cell by indicating an index of the candidate cell configuration associated with the LTM candidate cell. In some implementations, the first DCI field may include a bit to indicate that the transmission of the preamble is the initial transmission or the re-transmission. In a case that the bit is “0”, the bit indicates that the transmission of the preamble is the initial transmission, and in a case that the bit is “1”, the bit indicates that the transmission of the preamble is the re-transmission. In some implementations, the first DCI field may indicate that the transmission of the preamble is the re-transmission. The PDCCH order may further indicate an SSB for the re-transmission of the preamble for the LTM candidate cell. The SSB may be the same as an SSB that was used in a previous transmission of the preamble for the LTM candidate cell.

In action 206, the BS may receive, from the UE, the preamble based on a PRACH resource configured by a candidate cell configuration, among multiple candidate cell configurations. The candidate cell configuration may be associated with the LTM candidate cell. Process 200 may then end.

The technical problem addressed by the present disclosure may include how to ensure efficient and reliable performance of an RA procedure for LTM in a wireless communication system. This involves managing the initial transmission and re-transmissions of the preambles during the RA procedure, particularly when dealing with multiple candidate cell configurations and synchronization signal blocks (SSBs).

By incrementing a power ramping counter and adjusting the power parameter based on this counter, the implementations of the present disclosure ensure that the re-transmission power of the preamble is appropriately adjusted, enhancing the likelihood of a successful RA procedure completion. Additionally, by taking into account the SSBs from previous transmissions, the implementations ensure a more accurate synchronization and reduce a risk of failure in handover procedures. This may lead to more efficient use of power and also improved reliability of the RA procedure, thereby enhancing the overall system performance and user experience in a mobile communication environment.

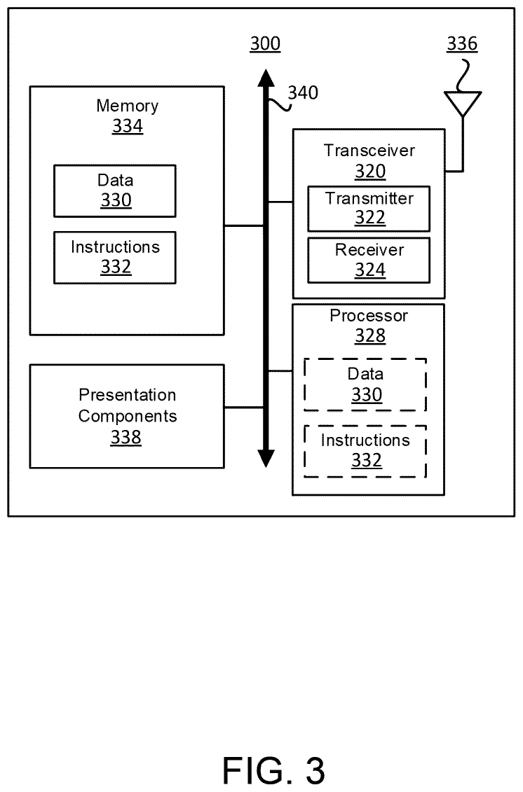

FIG. 3 is a block diagram illustrating a node 300 for wireless communication in accordance with various aspects of the present disclosure. As illustrated in FIG. 3, a node 300 may include a transceiver 320, a processor 328, a memory 334, one or more presentation components 338, and at least one antenna 336. The node 300 may also include a radio frequency (RF) spectrum band module, a BS communications module, a network communications module, and a system communications management module, Input/Output (I/O) ports, I/O components, and a power supply (not illustrated in FIG. 3).

Each of the components may directly or indirectly communicate with each other over one or more buses 340. The node 300 may be a UE or a BS that performs various functions disclosed with reference to FIG. 1 and FIG. 2.

The transceiver 320 has a transmitter 322 (e.g., transmitting/transmission circuitry) and a receiver 324 (e.g., receiving/reception circuitry) and may be configured to transmit and/or receive time and/or frequency resource partitioning information. The transceiver 320 may be configured to transmit in different types of subframes and slots including, but not limited to, usable, non-usable, and flexibly usable subframes and slot formats. The transceiver 320 may be configured to receive data and control channels.

The node 300 may include a variety of computer-readable media. Computer-readable media may be any available media that may be accessed by the node 300 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the previously listed components should also be included within the scope of computer-readable media.

The memory 334 may include computer-storage media in the form of volatile and/or non-volatile memory. The memory 334 may be removable, non-removable, or a combination thereof. Example memory may include solid-state memory, hard drives, optical-disc drives, etc. As illustrated in FIG. 3, the memory 334 may store a computer-readable and/or computer-executable instructions 332 (e.g., software codes) that are configured to, when executed, cause the processor 328 to perform various functions disclosed herein, for example, with reference to FIG. 1 and FIG. 2. Alternatively, the instructions 332 may not be directly executable by the processor 328 but may be configured to cause the node 300 (e.g., when compiled and executed) to perform various functions disclosed herein.

The processor 328 (e.g., having processing circuitry) may include an intelligent hardware device, e.g., a Central Processing Unit (CPU), a microcontroller, an ASIC, etc. The processor 328 may include memory. The processor 328 may process the data 330 and the instructions 332 received from the memory 334, and information transmitted and received via the transceiver 320, the baseband communications module, and/or the network communications module. The processor 328 may also process information to send to the transceiver 320 for transmission via the antenna 336 to the network communications module for transmission to a CN.

One or more presentation components 338 may present data indications to a person or another device. Examples of presentation components 338 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

What is claimed is:

1. A method for performing, by a user equipment (UE), a random access (RA) procedure for layer 1 (L1)/layer 2 (L2)-triggered mobility (LTM), the method comprising:
receiving, from a source cell, a plurality of candidate cell configurations;
receiving, from the source cell, a physical downlink control channel (PDCCH) order for initiating the RA procedure for an LTM candidate cell, the PDCCH order indicating that an index of a preamble for the RA procedure is not “0” and comprising a first downlink control information (DCI) field indicating that a transmission of the preamble is an initial transmission or a re-transmission and a second DCI field indicating the LTM candidate cell;
incrementing a power ramping counter by 1 in a case that the first DCI field indicates that the transmission of the preamble is the re-transmission and the PDCCH order further indicates a synchronization signal block (SSB) for the re-transmission of the preamble for the LTM candidate cell, the SSB being the same as an SSB that was used in a previous transmission of the preamble for the LTM candidate cell;
setting, based on the incremented power ramping counter, a power parameter for the re-transmission of the preamble; and
re-transmitting, to the LTM candidate cell, the preamble based on the set power parameter and a physical random access channel (PRACH) resource configured by a candidate cell configuration of the plurality of candidate cell configurations, wherein the candidate cell configuration is associated with the LTM candidate cell.

2. The method of claim 1, wherein the second DCI field indicates the LTM candidate cell by indicating an index of the candidate cell configuration associated with the LTM candidate cell.

3. The method of claim 1, wherein:
the first DCI field includes a bit to indicate that the transmission of the preamble is the initial transmission or the re-transmission,
in a case that the bit is “0”, the bit indicates that the transmission of the preamble is the initial transmission, and
in a case that the bit is “1”, the bit indicates that the transmission of the preamble is the re-transmission.

4. A user equipment (UE) for performing a random access (RA) procedure for layer 1 (L1)/layer 2 (L2)-triggered mobility (LTM), the UE comprising:
at least one processor; and
at least one non-transitory computer-readable medium coupled to the at least one processor, and storing one or more computer-executable instructions that, when executed by the at least one processor, cause the UE to:
receive, from a source cell, a plurality of candidate cell configurations;
receive, from the source cell, a physical downlink control channel (PDCCH) order for initiating the RA procedure for an LTM candidate cell, the PDCCH order indicating that an index of a preamble for the RA procedure is not “0” and comprising a first downlink control information (DCI) field indicating that a transmission of the preamble is an initial transmission or a re-transmission and a second DCI field indicating the LTM candidate cell;
increment a power ramping counter by 1 in a case that the first DCI field indicates that the transmission of the preamble is the re-transmission and the PDCCH order further indicates a synchronization signal block (SSB) for the re-transmission of the preamble for the LTM candidate cell, the SSB being the same as an SSB that was used in a previous transmission of the preamble for the LTM candidate cell;
set, based on the incremented power ramping counter, a power parameter for the re-transmission of the preamble; and
re-transmit, to the LTM candidate cell, the preamble based on the set power parameter and a physical random access channel (PRACH) resource configured by a candidate cell configuration of the plurality of candidate cell configurations, wherein the candidate cell configuration is associated with the LTM candidate cell.

5. The UE of claim 4, wherein the second DCI field indicates the LTM candidate cell by indicating an index of the candidate cell configuration associated with the LTM candidate cell.

6. The UE of claim 4, wherein:
the first DCI field includes a bit to indicate that the transmission of the preamble is the initial transmission or the re-transmission,
in a case that the bit is “0”, the bit indicates that the transmission of the preamble is the initial transmission, and
in a case that the bit is “1”, the bit indicates that the transmission of the preamble is the re-transmission.

7. A method for performing, by a base station, a random access (RA) procedure for layer 1 (L1)/layer 2 (L2)-triggered mobility (LTM), the method comprising:
transmitting, to a user equipment (UE), a plurality of candidate cell configurations;
transmitting, to the UE, a physical downlink control channel (PDCCH) order for initiating the RA procedure for an LTM candidate cell, the PDCCH order indicating that an index of a preamble for the RA procedure is not “0” and comprising a first downlink control information (DCI) field indicating that a transmission of the preamble is an initial transmission or a re-transmission and a second DCI field indicating the LTM candidate cell; and
receiving, from the UE, the preamble based on a physical random access channel (PRACH) resource configured by a candidate cell configuration of the plurality of candidate cell configurations, wherein the candidate cell configuration is associated with the LTM candidate cell.

8. The method of claim 7, wherein the second DCI field indicates the LTM candidate cell by indicating an index of the candidate cell configuration associated with the LTM candidate cell.

9. The method of claim 7, wherein:
the first DCI field includes a bit to indicate that the transmission of the preamble is the initial transmission or the re-transmission,
in a case that the bit is “0”, the bit indicates that the transmission of the preamble is the initial transmission, and
in a case that the bit is “1”, the bit indicates that the transmission of the preamble is the re-transmission.

10. The method of claim 7, wherein:
the first DCI field indicates that the transmission of the preamble is the re-transmission, and
the PDCCH order further indicates a synchronization signal block (SSB) for the re-transmission of the preamble for the LTM candidate cell, the SSB being the same as an SSB that was used in a previous transmission of the preamble for the LTM candidate cell.
